(19) United States
(12) Patent Application Publication
(10) Pub. No.: US 2018/0216784 A1
(43) Pub. Date: Aug. 2, 2018

(54) Circulating inert-gas seal system based on gas-supply servo device and QHSE based storage and transportation method

(71) Applicant: Qiangdan Sun, Beijing (CN)

(72) Inventors: Qiangdan Sun, Beijing (CN); Yuntao Mu, Beijing (CN)

(73) Assignee: Qiangdan Sun

(21) Appl. No.: 15/936,432

(22) Filed: Mar. 27, 2018

(30) Foreign Application Priority Data
Mar. 27, 2017 (CN) 201710187784.7

(51) Int. Cl. F17D 1/05; F17D 3/01; F17D 1/07; F17D 5/00; F17C 5/06; F17C 13/04; F17C 13/02

(52) U.S. Cl. CPC F17D 1/05; F17D 3/01; F17D 1/07; F17D 5/005; F17C 2250/043; F17C 13/04; F17C 13/025; F17C 2221/033; F17C 2223/0123; F17C 5/06

(57) ABSTRACT

A circulating inset-gas seal system based on gas-supply servo device and QHSE based storage and transportation method are provided. The gas-supply servo device includes a servo constant pressure unit including: inlet gas compressors a charging check valve, a gas supply container and a degassing valve control unit which are connected in sequence and communicated and controlled by a one-way valve. According to a preset gas pressure of the gas phase space in the material container, a inert sealing medium filled in the material container group is received, stored and released via an inerting pipe to form a station-type circulating inert seal system. A multi-group circulating inerting system cooperates with a mobile material container for self-sealing loading and unloading, which is capable of realizing a QHSE storage and transportation system with no gas phase emission.

### CROSS REFERENCE OF RELATED APPLICATION

The present application claims priority under 35 U.S.C. 119(a-d) to CN 201710187784.7, filed Mar. 27, 2017.

### BACKGROUND OF THE PRESENT INVENTION

### Field of Invention

The present invention relates to the field of the storage and transportation technique of the liquid hazardous chemicals in bulk, and more particularly to the field of autonomous defense technique for military oil supply projects. Specifically, the present invention relates to a gas-supply servo device, a circulating inert-gas seal system based on the gas-supply servo device and an integrated storage and transportation method based on the quality, health, safety and environmental (QHSE) of the system.

### Description of Related Arts

Materials with strategic resource attributes, such as oil and its products, are both a support for national strength and a component for combat power. As such materials and their storage and transportation methods, engineering facilities and technical equipment are in common use of military-civil aspects, it is inevitable that they will become the focus of strategic interests and the key tactical attack and defense in the military struggle. However, under the current background of contemporary attack forces, which are commonly deployed and commonly encountered in actual combat and normal deterrence, the front-stage earth-boring and/or container detonation, and then devastated oil and gas, detonated materials, resulting in the overall chemical explosion attack after the significant damage, cost-effective, is to destroy the military oil supply project, the national strategic reserve, chemical industry park, and ship, ship power oil cabinet, roads, railway tankers and other important military and economic goals of the basic model, the election of the best species and tactics. Therefore, the self-defense capability for dealing with detonation mode attack in containers is indispensable, under the condition that the existing self-defense technology for military fuel supply projects is limited to the cave depot hidden engineering and fire protection technology.

In addition, it is well-known that bulk liquid hazardous chemicals generate volatile organic compounds (VOCs) due to inter-phase mass transfer, which are not only well-known precursors, carcinogens, haze contributors, but also focus on monitoring and controlling objectives by the government which involves public safety, life and health, environmental protection, cleaner production, material quality and energy-saving emission reduction and other areas. However, the conventional art in different areas involving bulk liquid hazardous chemicals and containers often run counter to one another. For example, in the case of a container without an inner floating roof being regarded as an unorganized discharge technology, the existing inner floating roof storage tank is provided with ventilation windows to ensure smooth breathing and eliminate the safety risk of hydrocarbon accumulation. However, air pollution caused by the continuity of the volatile, escape on the sealing device has not been included as a mandatory control areas; the conventional floating roof with nitrogen sealing technology further ensures the system oxygen safety and inhibits material oxidation and deterioration, but while the mass transfer products are expelled from the storage tank and accompanied by the process of nitrogen bleed, the environmental pollution and the safety hazard at the pressure relief valve port have not been solved yet. The conventional self-sealing gas-liquid exchange recovery technology reduces the material handling, but the air serves as a medium to balance the import and export side of the container process, which causes a result that that explosion risk of the container material mixture in the output side suddenly increases, and the recycling technique is not suitable for all types of floating roof tank.

Therefore, technical solutions aimed at the normal isolation of the atmosphere, dynamic circulating inert seal, gas-free emissions, low operating costs and application to the overall storage and transportation network and value orientation of technological advancement in this area, are both a necessary path of integrated QHSE in engineering and an inevitable choice for generating self-defense capabilities.

At present, a Chinese patent with an application number of ZL201410169718.3 and entitled Inert sealer and anti-explosion equipment for hazardous chemicals containers and defense method therefor, which is invented by identical applicants to the present invention, provides the anti-explosion technical solutions. Although the technical solution achieves the technical purpose of filling the gaseous space of the material container with the circulating gaseous inert medium, the method is capable of controlling the normalization of the oxygen content less than the limit of the combustion and explosion of the protected material and capable of permanently suppressing the combustion and explosion conditions of the hazardous chemicals in the container However, this solution only gives a general realization of the gaseous inert medium source, and fails to focus on the internal structure of the inert media source, the connection relationship, as well as control methods and technical requirements for material container group and storage chain network.

In order to remedy the deficiencies of the conventional arts, the present invention provides a gas-supply servo device for improving the efficiency and performance of a gaseous inert seal medium source, a circulating inert-gas seal system based on the device and a QHSE storage and transportation method based on the system, so as to achieve a chain-network type QHSE integrated storage and transportation system.

### SUMMARY OF THE PRESENT INVENTION

A first object of the present invention is to provide a gas-supply servo device capable of receiving, storing and releasing working gas at the right time or at the same time.

A second object of the present invention is to provide a circulating inert-gas seal system based on the gas-supply servo device capable of controlling a gas phase space of a container filled with inert sealing medium driven out of oxygen.

A third object of the present invention is to provide a circulating inert-gas seal system based on the gas-supply servo device capable of effectively overcoming influences of gas-liquid ratio during the process of self-enclosed loading and unloading, so as to receive and store the inert sealing medium under pressure.

A fourth object of the present invention is to provide a circulating inert-gas seal system based on the gas-supply servo device capable of arbitrarily increasing storage amount of the inert sealing medium.

A fifth object of the present invention is to provide a circulating inert-gas seal system based on the gas-supply servo device capable of eliminating, disposing and utilizing a chemical device to safely discharge gas.

A sixth object of the present invention is to provide a QHSE storage and transportation method based on the circulating inert-gas seal system, which is capable of realizing a QHSE integrated system of a full storage and transportation chain.

A seventh object of the present invention is to provide a QHSE storage and transportation method based on the circulating inert-gas seal system, which is capable of remotely humping early warning signals representing inherent safety of the system.

An eighth object of the present invention is to provide a QHSE storage and transportation method based on the circulating inert-gas seal system, which is capable of avoiding atmospheric forced sampling mode inspection by a manner of without gas phase discharge.

A ninth object of the present invention is to provide a QHSE storage and transportation method based on the circulating inert-gas seal system, which is capable of generating a defensive force coping with the detonation of the incoming warhead in a container.

Accordingly, in order to achieve one of the objects mentioned above, the present invention provides a gas-supply servo device, comprising: a servo constant pressure unit for supplying, receiving and storing working gas; wherein the servo constant pressure unit comprises: inlet gas compressors which are connected in sequence and communicated and controlled by a one-way valve, a charging check valve, a gas supply container and a degassing valve control unit;

wherein the inlet gas compressors are capable of controlling the start-up and shutdown interlock in automatic, interlocking and\or manual modes, so as to output power to compress and charge the working gas at an inlet side into the gas supply container; so as to feedback control a state of the working gas at the inlet side to be maintained within a range of not greater than a first preset pressure parameter;

the charging check valve, which is matched with a rated exhaust pressure of the inlet gas compressors, is provided on a pipe between an exhaust side of the inlet gas compressors and an inlet side of the gas-supply container, so as to assist the gas-supply container to receive and store the working gas and accumulate pressure potential energy;

the gas-supply container is matched with the rated exhaust pressure and a preset receiving and storing amount of the inlet gas compressor, so as to receive, store and supply the working gas; and

the degassing valve control unit is capable of controlling opening and closing in an independent, automatic, interlocking and/or manual mode to control the working gas in the gas supply container to be throttled and decompressed to be released to a degassing side of the degassing valve control unit, and to feedback control a state of the working gas at the degassing side of the degassing valve control unit to be maintained within a range of not less than a second preset pressure parameter.

Preferably, the inlet gas compressor is equipped with a first pressure transmitter, wherein the first pressure transmitter is provided on a pipe on an inlet side of the inlet gas compressor, so as to directly communicated and connected with the inlet compressor or via a control system to detect pressure variable of working gas at the inlet side of the inlet compressor and push a first preset pressure parameter transmission signal for automatically controlling the start-up and shutdown interlock of the inlet compressor.

Preferably, the gas-supply servo device further comprises a gas source turnover unit for expanding a volume of the working gas and being capable of outputting the working gas to an external and/or an internal; the gas source turnover unit comprises: a gas storage booster, a charging and filling check valve, a turnover container and a compensation valve control unit which are sequentially connected and communicated by a one-way valve;

wherein an inlet side of the gas storage booster is in one-way connection with the gas supply container and communicated by valve control; the gas storage booster is capable of controlling start-up and stop interlock in an automatic, interlocking and\or manual mode, so as to output power to transfer the working gas in the gas-supply container to further compress and discharge and fill the working gas to the turnover container, and feedback control the working gas in the gas-supply container to be maintained in a range of not exceeding the preset pressure parameter;

the charging and filling check valve which is matched with a rated exhaust pressure of the gas storage booster, is provided on a pipe between an side of the gas storage booster and an inlet side of the turnover container, so as to assist the turnover container to receive and store the working gas and accumulate pressure potential energy;

the turnover container is matched with a rated discharge pressure and a preset receiving and storing amount of the gas storage booster for accumulating pressure potential energy to store and circulate the working gas;

the compensation valve control unit is capable of controlling opening and closing in an independent, automatic, interlocking and/or manual mode to control the working gas in the turnover container to be throttled and decompressed to be released to the gas supply container, and to feedback control a state of the working gas in the gas-supply container to be maintained within a range of not less than a preset pressure parameter.

Preferably, the gas storage booster is an electric drive booster, a second pressure transmitter is provided on an inlet side of the electric drive booster, so as to directly communicated and connected with the electric drive booster or via a control system to detect pressure variable of the working gas in the gas-supply container and push a second preset pressure parameter transmission signal for automatically controlling the start-up and shutdown interlock of the gas storage booster.

Preferably, the gas-supply servo device further comprising a gas-supply turnover unit for expanding a volume of the working gas and being capable of outputting the working gas to an external and/or inputting the working gas to an internal; wherein the gas-supply turnover unit comprises: a gas storage booster, a charging and filling check valve, a turnover container and a compensation valve control unit which are sequentially s and communicated by a one-way valve; wherein the gas storage booster is a gas drive booster, the gas drive booster has a drive gas input interface, a drive gas output interface, a working gas inlet and a working gas outlet; the gas drive booster is also equipped with a relay container for driving a gas recycle pipe, a driving gas recycle pipe and a recycle gas pressure relief valve for driving the gas drive booster to operate via a driving gas of the working gas discharged by the inlet gas compressor;

an air outlet of the inlet compressor is in a one-way connection and communication with a driving gas input port of the gas drive booster; the relay container is connected in series to a pipe between the driving gas outlet and a working gas inlet, the driving gas passes through the relay container to the working gas inlet; the working gas outlet is connected and communicated with the inlet of the turnover container by the charging and filling check valve in a non-return way;

an outlet side of the compensation valve control unit is connected and communicated with the gas-supply container in one way; the compensation valve control unit is capable of controlling opening and closing in an independent, automatic, interlocking and/or manual mode to control the working gas in the turnover container to be throttled and decompressed to be released to the gas supply container, and to feedback control a state of the working gas in the gas-supply container to be maintained within a range of not less than a preset pressure parameter;

the driving gas recycle pipe is connected on an inlet side of the relay container and the inlet compressor; the circulating gas pressure relief valve is connected in series with the driving gas recycle pipe to limit pressure of the working gas in the relay container, so as to ensure a driving gas pressure difference between the driving gas inlet and the driving gas outlet.

Preferably, the turnover container is a ready packaged steel cylinder unit; each steel cylinder of the ready packaged steel cylinder unit comprises a charging and discharging assembly; the gas supply turnover unit further comprises a charging and discharging converge unit; wherein the charging and discharging converge unit comprises: a gas input interface, a gas output interface and a steel cylinder interface; the gas input interface of the charging and discharging converge unit is connected on a gas output side of the charging and filling check valve, the gas output interface is connected on a gas input side of the compensation valve control unit; the steel cylinder interface is respectively connected and communicated with the charging and discharging assembly of each of the steel cylinder by a two-way valve.

Preferably, the turnover container is a ready packaged steel cylinder unit; each steel cylinder of the ready packaged steel cylinder unit comprises a charging and discharging assembly; the servo constant pressure unit further comprises a charging and discharging converge unit; wherein the charging and discharging converge unit comprises: a gas input interface, a gas output interface and a steel cylinder interface; the gas input interface of the charging and discharging converge unit is connected on a gas output side of the charging and filling check valve, the gas output interface is connected on a gas input side of the compensation valve control unit; the steel cylinder interface is respectively connected and communicated with the charging and discharging assembly of each of the steel cylinder by a two-way valve.

Preferably, a gas heating device is provided on the compensation valve control unit, so as to prevent decompression freezing blockage of the compensation valve control unit.

Preferably, an amount of the inlet gas compressors is at least two, an amount of the gas storage boosters is at least two; wherein the inlet gas compressors and the gas storage boosters respectively connected in parallel and are capable of being started one after another and respectively shutdown for interlock, so as to adapt to operating conditions for serving as mutual backup and emergency sharing.

In order to achieve one of the objects mentioned above, the present invention provides a circulating insert-gas seal system based on the gas-supply servo device as recited in claim 1, comprising: the gas-supply servo device, an insert-gas seal pipe and a material container; wherein the working gas is an inert sealing medium which is a gas-type fire-fighting medium applied by a suffocation fire-fighting method; wherein the gas-supply servo device has an inlet interface and an outlet interface; the inlet interface is the inlet port of the inlet gas compressors, the outlet interface is the outlet port of the gas outlet valve control unit; the insert-gas seal pipe comprises an inlet pipe and an outlet pipe; an expiration output interface and an inspiration input interface; wherein the expiration output interface of the material container is connected in sequence with the inlet port of the gas-supply servo device via the inlet pipe and communicated and controlled by a first one-way valve; the inspiration input interface of the material container is connected in sequence with the outlet port of the gas-supply servo device via the outlet pipe and communicated and controlled by a second one-way valve, so as to feedback control gas conditions of the insert sealing medium in a gas phase space of the material container.

Preferably, the gas-supply servo device further comprises a servo temperature regulating unit for feedback controlling a temperature of the gas phase space of the material container in an automatic, interlocking and/or manual mode.

Preferably, the servo temperature regulating unit comprises: a working gas cooling device provided on an exhaust side of the inlet gas compressor and/or a working gas heating device provided on a degassing side of the degassing valve control unit, and a temperature transmitter provided on the inlet pipe or the outlet pipe; wherein the temperature transmitter is connected and communicated with the inlet gas compressors directly or via a control system, so as to detect a temperature variable of the gas phase space of the material container and push a preset temperature parameter transmission signal for automatically controlling a start-up operation and shutdown interlock of the inlet gas compressors.

Preferably, a temperature regulating structure is cover on an external of the material container; the temperature regulating structure is made of airtight metal and/or non-metal, hard and\or soft material, an interlayer space separated from the atmosphere is formed between an internal wall of the temperature regulating structure and an external surface of the material container; the insert seal pipe is communicated with the gas-phase space of the material container via the interlayer space, so as to control temperature of materials in the material container by regulating temperatures of the gas-phase space in the material container and the interlayer space.

Preferably, the circulating insert-gas seal system further comprises a gas source purifying unit, wherein the gas source purifying unit comprises a micro-pressure difference purifying unit and/or a saturation purifying unit, the gas source purifying unit is configured to control condensable or filterable gaseous substances in the insert sealing medium in a linked, automatic and/or manual mode; wherein the micro-pressure difference purifying unit is connected in parallel with the inlet pipe, wherein connection and communication is switched by a first switching valve group which comprises a first through gear and a first purifying gear; the saturation purifying unit is provided in parallel with the pipe between the charging check valve and the gas-supply container in the gas-supply servo device and is connected and communicated by a second switching valve group; wherein the second through gear and a second purifying gear.

Preferably, the micro pressure difference purifying component specifically comprises a micro-pressure difference gas-liquid separation device, a purge product diverter valve tube and a liquid product collection container, wherein a bottom of the micro-pressure difference gas-liquid separation device is in one-way connection with the liquid product collection container through the purifying product diversion valve tube, the liquid phase valve is controlled in communication with the liquid phase to drain the liquid phase in the micro-pressure difference condition, and the liquid Phase absorbing, purging, converging, and recovering liquid-phase purified products and mechanical impurities flowing through its own inerting medium; and the saturated purification component specifically includes a pressure-type gas matching the rated discharge pressure of the incoming compressor Liquid separation device, a first back pressure valve, a purge product diversion valve pipe and a liquid product product collection container, wherein the first back pressure valve is disposed on the degassing side pipe of the pressure-type gas-liquid separation device, and the The bottom of the pressure-type gas-liquid separation device is unidirectionally connected to the liquid product collection container via the purifying product diversion valve tube and is in liquid-phase valve control for leaching, drawing and grooming under a pressure condition, confluence and recycling flow through their own lazy seal Interstitial liquid in the purified product.

Preferably, the air source purifying unit further comprises a gas-liquid separation device produced by a method selected from a group consisting of a filter method, an absorption method, an adsorption method, a membrane separation method and a condensation method, so as to cooperate with the micro-pressure differential gas-liquid separation device and/or the pressure-type gas-liquid separation device to enhance function and/or improve efficiency.

Preferably, the circulating insert-gas seal system further comprises a gas source purifying unit, wherein the gas source purifying unit comprises a third switch valve group and a non-condensable impurity gas removal unit; the third switch valve group comprises a through-going gear and a purifying gear, the non-condensable gas removal unit and the pipeline between the gas-filled check valve and the gas source container are arranged in parallel, and the third switchover valve; a valve bank switching connection is provided for removing the non-condensable or difficult-to-coagulant-type impurity gas in the inert packing medium in an interlocked, automatic and/or manual mode; the impurity gas comprises at least oxygen.

Preferably, the non-condensable impurity gas removal unit specifically comprises a pressure swing adsorption nitrogen generator, an air compressor, a product removal pipe and a fourth switch valve group, wherein the fourth switch valve group comprises a purification file and a nitrogen gear, wherein the air compressor is provided in parallel with an air inlet side pipeline of the pressure swing adsorption nitrogen generating unit, and is connected and communicated by the fourth switch valve group; the removal products generated by the PSA nitrogen generator are diverted to the collection device or safely vented through the removal product drain conduit.

Preferably, a predetermined gas content sensor is provided on the inlet gas compressor, which is an interconversion product of oxygen, nitrogen and materials at least one of the gas content sensor, the predetermined gas content sensor directly connected and communicated with, or via a control system and the intake compressor, the first switching valve group, the second switching valve group, the third switching valve group and or a fourth switching valve set for detecting a predetermined gas content of the gas phase space of the material container and for pushing an automatic control of the starting gas compressor start and stop interlocks and the first switching valve set, the second switching valve set, the third switching valve set and the fourth switching valve set automatically switches the predetermined gas content of the predetermined parameter transmission signal.

Preferably, a buffer container is connected in series in the inert sealing pipe, and the interior of the buffer container is provided with a fire-proof and explosion-proof material for discharging the oxygen between the material containers, and between the material container and the gas source servo device.

Preferably, the buffer container comprises a gas buffer container connected in series with the gas inlet and the gas outlet in the gas line, and a degassing buffer container connected to the degassing line in series and having a degassing input port and a degassing output port, wherein the breath output interface of the material container is connected to the degassing gas passage via the gas conduit, the air supply buffer and the air supply interface of the air source servo device are connected and valve-controlled in sequence; the air removal interface of the air source servo device is connected to the air supply port of the air source servo device via the air removal buffer via the air removal buffer container, The suction inlet of the material container is in turn connected and valve-controlled in one-way.

Preferably, at least two of the material containers are used, at least two gas inlet ports of the gas buffer container are provided, wherein the exhalation output interfaces of the respective material containers are connected to the corresponding gas inlet ports in the gas buffer container via the corresponding gas pipelines respectively; and the degassing buffer container of the respective gas output port is respectively connected and communicated with the corresponding degassing line and the corresponding material container suction inlet.

Preferably, the material container comprises a fixed material container, a movable material input container and a movable material output container; a gas acceleration component is also connected in series with the inlet gas pipe, and a degassing acceleration component is also connected in series in the degassing pipeline, both the gas acceleration component and the degassing acceleration component comprise a pipeline fan to speed up the inerting medium at And the speed of loading and unloading of the liquid phase material is accelerated; the fixed material container can be in liquid phase connection with the movable material input container and/or the movable material output container, And the material in the input side of the movable material is unidirectionally connected to the air inlet of the air source servo device via the gas supply line via the gas buffer container and the gas acceleration assembly, the gas phase space of the container on the output side of the moving material passes through the degassing pipe, the degassing buffer container, the degassing accelerating assembly, the degassing of the gas source servo device valve opening are connected and communicated by one-way valve.

Preferably, the material container has a breathing interface, the inert seal pipe comprises a gas inlet pipe, a gas removal tube and a breathing tube, the buffer container has a breath outlet port, a degassing input port, and a breath port, wherein the breath port of the material container is bidirectionally connected to the breath port of the buffer container through the breath tube; the gas supply to the buffer container; the output port is unidirectionally connected to the air supply interface of the air source servo device through the air supply pipeline and is in valve-controlled communication; the degassing interface of the air source servo device is connected to the buffer container through the degassing pipeline one-way inlet connection and valve control connectivity.

Preferably, at least two of the material containers are used, and at least two respiratory gas ports of the buffer container are used, wherein breathing ports of the respective material containers respectively pass through the respective breathing tubes are bidirectionally connected to the corresponding breathing gas ports on the buffer container.

Preferably, the buffer container is a bridging buffer container, and the material container further comprises a manufacturing device container, and a raw material container and a product-side container, wherein the raw material side container, the production device container and the product-side container are sequentially and unidirectionally connected and communicated with the liquid-phase connected and in valve-controlled communication, wherein the breathing ports of the material-side container and the product-side container respectively communicate with each other through respective breathing circuits and each breathing gas port of the bridging buffer container is in gas-phase connection and is used for flowing the inert seal medium under the action of the liquid level of the material.

Preferably, the production device container further comprises a safety vent gas pipe, and the bridging buffer container further comprises a production device safety vent gas input interface, the safety vent gas line of the production device container communicates with the non-return one-way connection of the production device safety vent gas input interface of the bridging buffer container to make the safety vent gas of the production device container pass through the bridging buffer container is fire-resistant, explosion-proof and cushioned, is disposed of in the raw material container and the product-side container, and is purified, purified and utilized in the air source servo device.

Preferably, the gas buffer container further comprises an external gas source input interface, and the gas degassing buffer container further comprises an internal gas source output interface.

In order to achieve one of the objects, the present invention provides a QHSE (quality, health, safety and environmental) storage and transportation method based on the circulating insert-gas seal system, as recited in claim 10, wherein the air inlet compressor is provided with a first pressure transmitter, and the first pressure transmitter is installed on the pipeline on the gas side of the incoming gas compressor and is connected and communicated with the incoming gas compressor directly or via a control system to detect whether the incoming gas compressor pressure variable and pushing a preset pressure parameter transmission signal for automatically controlling the start-up of the incoming compressor and the shutdown interlock;

the QHSE storage and transportation method comprises following automatic servo respiration steps of:

the first pressure transmitter detects in real time a pressure variable for characterizing a state of inerting medium in a gas-phase space of the material container;

when the pressure variable rises to a first preset pressure threshold, the gas source servo device starts a gas-in procedure: the gas-in compressor starts operation, and part of the inerting medium in the gas-phase space is transferred and compressed Storing the gas to the air source container until the pressure variable falls back to a second preset pressure threshold that is not higher than the first preset pressure threshold and the air compressor is stopped and interlocked,

when the pressure variable drops to a third predetermined pressure threshold that is not higher than the second preset pressure threshold, the air source servo device starts the air supply program: the purge valve control module is turned on, and the After the inerting medium in the gas source container is throttled and depressurized, it is released to the gas space of the material container until the pressure variable rises to a second preset pressure threshold, and the degassing valve control assembly is closed Gas program is over.

Preferably, the air source servo device further comprises a servo temperature control unit, and the servo temperature control unit specifically comprises a servo control unit mounted on the air compressor row A gas-side refrigerant gas cooling device and/or a refrigerant gas heating device installed on the gas-inlet side of the degassing valve control module and a temperature transmitter installed on the gas-supply line and/or the degassing line Wherein the temperature transmitter is in communication with the incoming air compressor directly or via a control system to detect a temperature variable of the gas space of the material container and push a temperature sensor for controlling the incoming air compressor Start running and stop interlocking preset temperature parameter transmission signal;

the QHSE based storage and transportation method further comprises a temperature regulating step:

the temperature transmitter detects the temperature variable for characterizing the gas state of the gas phase space of the material container in real time;

when the temperature variable reaches a first preset temperature threshold, the gas source servo device activates the gas-in procedure: the gas-out compressor outputs a part of the inerting medium to be warmed in the material container Transferring and compressing and filling to the gas source container through the inerting pipe, and accumulating gas pressure potential energy;

when the pressure variable drops to a third predetermined pressure threshold that is not higher than the second preset pressure threshold, the air source servo device starts the air supply program: the purge valve control module is turned on, and the inerting medium in the gas source container is throttled, decompressed and tempered to be released into the gas space of the material container;

when the temperature variable reaches a preset second temperature threshold corresponding to a desired temperature, the gas compressor stops interlocking and the gas collection process stops; and when the gas removal valve control module senses the second pre-control valve When the pressure threshold is set, the air supply program is stopped, and the automatic temperature control step is ended.

Preferably, the material container comprises a fixed material container, a movable material input container and a movable material output container, wherein the gas supply conduit is further connected in series, a gas acceleration component is provided, and the gas removal acceleration component is also connected in series in the gas removal pipeline; the QHSE storage and transportation method further comprises the following material collection acceleration steps and material acceleration steps:

when the movable material output side container is liquid-phase connected with the fixed material container in the circulating inert sealing system to perform the material receiving operation, the gas-phase space of the movable-material output-loop inerting system connected to the gas pipeline connection;

in the process that the fixed material container receives the material in the movable material output side container, the inerting medium to be purified in the fixed material container flows through the gas inlet pipe, through the gas buffer container and Gas accelerating component to the gas source servo device, and the pure inerting medium in the gas source servo device is sent to the gas-accelerating component through the degassing pipeline, the degas acceleration component and the degassing buffer container, to the gas source servo device, Moving the material output side of the container, until the gas-liquid exchange receiving operation ends, the receiving acceleration step is ended;

when the movable material input side container is connected to the fixed material container in the circulating inert sealing system in a liquid phase to perform the material dispensing operation, the gas phase space of the movable material input side container and the liquid phase space of the Loop inert gas system connected to the gas pipeline connection;

during the process of inputting the fixed material container into the movable material input container, the pure inert medium in the gas source servo device passes through the degassing pipe, the degassed acceleration assembly and the Gas buffer container is conveyed to the fixed material container, the inert material and/or air to be purified in the movable material input container are passed through the gas supply line, and the gas buffer container and the gas supply The accelerator assembly is delivered to the air source servo until the gas-liquid exchange dispensing operation is completed, and the material acceleration step ends.

Preferably, the QHSE storage and transportation method, further comprises the following steps of coercively sampling the atmosphere:

the material container is placed in a pit garage and the circulating inert seal system is operated to disable the atmospheric compulsory sampling reconnaissance capability.

Preferably, the QHSE storage and transportation method further comprises the following steps of generating defensive battle force:

operating the circulating inert seal system and detecting in real time the gas state variables inside or outside the gas phase space of the material container;

when the charge-breaking wall warhead penetrates the top or wall of the material container and penetrates into the hole with the warhead in the material container, the energy of detonation is released along the gas pipeline for Inhibit the chemical and/or physical explosion of the material;

the detonation energy triggers the air source servo device to start a forced cooling program: the air compressor is used to output a forced cooling force, and a part of inert medium in the material container is transferred, compressed and filled up to The gas source container, and cooling the inert sealing medium;

the degassing valve control assembly is opened to release the inerting medium in the gas source container to the gas space of the material container through cooling, throttling and decompression;

under the action of the air source servo device, a continuous or pulsating forced convection cycle of inert seal medium is formed in the material container to cool down continuously to continuously reduce the concentration of material vapor, hole to prevent air from entering the material container during discharge.

Based on the above technical solution, the present invention adopts the technical measures of storing and supplying the working gas by the servo constant pressure unit, and uses the start-up operation and stop-down interlocking of the gas compressor to compress and fill the gas at the gas-side to the gas Source container, and opening and closing of the valve control assembly with the degassing gas to release the working gas in the gas source container to the degassing side, and to realize the working gas device in the material container when applied to the circulating inert sealing system, so as to be effective To achieve the system and the system cycle lazy seal.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a circulating inert-gas seal system according to a first preferred embodiment of the present invention.

FIG. 2 is a schematic view of the circulating inert-gas seal system according to a second preferred embodiment of the present invention.

FIG. 3 is a schematic view of the circulating inert-gas seal system according to a third preferred embodiment of the present invention.

FIG. 4 is a schematic view of the circulating inert-gas seal system according to a fourth preferred embodiment of the present invention.

FIG. 5 is a schematic view of the circulating inert-gas seal system according to a fifth preferred embodiment of the present invention.

FIG. 6 is a schematic view of the circulating inert-gas seal system according to a sixth preferred embodiment of the present invention.

FIG. 7 is a schematic view of the circulating inert-gas seal system according to a seventh preferred embodiment of the present invention.

### DETAILED DESCRIPTION OF THE PREFERRED EMBODIMENT

Further description of the present invention is illustrated in detail combining with the accompany drawings and the preferred embodiments.

In the present invention, closed refers to the physical isolation from the atmosphere. Closed storage and transportation means that during the process of storing, loading and unloading containers of the liquid hazardous chemicals in bulk, the liquid hazardous chemicals are always in a closed state. “Inert media” refers to the choice of operating conditions and conditions, the use of suffocation fire-fighting methods commonly used gas-based fire-fighting media. The concept of “inert sealing” refers to “inert sealing storage and transportation with inert gas as balance gas and always filling gas space of storage tank”, especially permanent permanent storage and transportation with inert gas without gas phase discharge. The concept of inert packing is based on the well-known self-contained loading and unloading method, which can effectively eliminate the influence of gas-liquid ratio and safety risk. The concept of “cyclic inert includes, but is not limited to, the concept of “circulating closed inertial storage and transport using a inert medium to achieve a stationed cyclic inert system”, which includes, inter alia, a plurality of stationed cyclic inert systems Material containers, to achieve the concept of chain network cycle inert sealing system.

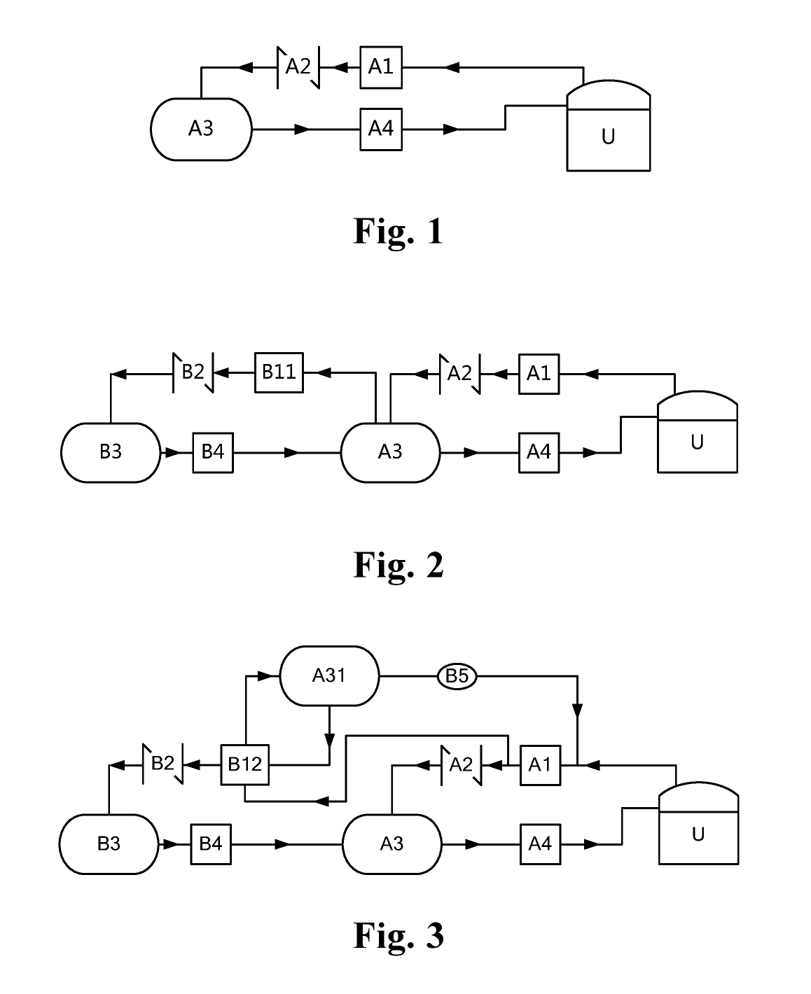

Referring to FIG. 1, FIG. 1 is a schematic view of a circulating inert-gas seal system according to a first preferred embodiment of the present invention. In the first preferred embodiment, the circulating inert-gas seal system comprises: a gas-supply servo device, an inert sealing pipe and a material container U, wherein working gas circulated in the gas-supply servo device, the inert sealing medium is a gas-type fire-fighting medium applied by a suffocation fire-fighting method.

In the first preferred embodiment, the insert sealing pipe comprises an inlet pipe and an outlet pipe. The material container U has an exhalation output interface and a suction input interface; wherein the exhalation output interface of the material container U is connected with inlet interfaces of the gas-supply servo device via the inlet pipe in sequence and communicated and controlled by a one-way valve. The degassing interface of the gas source servo device is connected to the intake interface of the material container U through the degassing pipeline in turn and the one-way valve control is communicated to control the gas state of the inerting medium in the gas phase space of the material container U.

In the circulating inert sealing system of the present embodiment, the gas source servo device is in gas-phase communication with the material container via an inerting pipe line, and the material container is flooded with the inerting agent through oxygen-evacuation to form a station-type cyclic inert gas seal storage and transportation system. The material container here can be either an independent, fixed-geometry container of any geometry, such as a dome jar, an inner floating roof tank with a closed ventilation window, an outer floating roof tank with a dome structure, a water seal tank and a ship Power oil tank, etc.), or a movable material container (for example, a tanker, a road tanker, a cargo tank on board and other types of cargo carriers), or a group consisting of different types of material containers. The inerting pipeline is a pipeline used to transport the inerting medium. The inerting medium flooded in the gas space of the material container can be discharged by the gas compressor in the gas source servo device and transferred to the gas source container through the inerting pipeline, The air source valve control component in the air source servo device can also provide the inerting medium in the air source container to the gas space of the material container via the inerting pipeline.

The gas source servo device can servo-guarantee the pressure of the inerting medium in the gas space in the material container to be constant within a preset range through the condition monitoring and feedback control of the working gas on the gas-side. In FIG. 1, a gas source servo device includes a servo constant pressure unit for storing and supplying working gas. The servo constant pressure unit specifically includes a gas compressor (A1), a gas check valve (A2), a gas source container (A3) and a degassing valve control assembly (A4), which are sequentially connected and controlled by a one-way valve. The air source servo device has a gas inlet and a gas outlet, the gas inlet is the gas inlet of the gas compressor A1, and the gas outlet is the outlet of the gas valve control assembly A4.

Compressor A1 can start and stop interlocking with automatic, interlocking and/or manual mode control to compress and charge its gas side working gas into gas source container A3 and feedback control Gas side of the state of the working gas, so that it is not greater than the preset pressure in the range of parameters. The inflation check valve A2 is matched with the rated exhaust pressure of the compressor A1, and is disposed on the pipeline between the outlet side of the compressor A1 and the inlet side of the source container A3 for cooperating with the air source container A3 Collect and store working gas and build pressure potential. The source container A3 is matched with the rated exhaust pressure of the compressor A1 and the preset storage volume for storing and supplying the working gas. The valve control assembly A4 can open and close in a self-operated, automatic, linkage and/or manual mode to control the working gas in the gas source container A3 to be throttled and decompressed to be released to the valve control assembly A4 Go to the gas side and feed back the state of the working gas at the degassing side of the degassing valve control assembly A4 so as to keep it within the range of not less than the preset pressure parameter.

In FIG. 1, the deaeration side is the material container U, and the aeration compressor A1 can be controlled automatically or in linkage according to the preset pressure threshold transmission signal of the inerting medium as the balancing working gas in the material container U Its own start-up and shutdown interlocking. In another embodiment, the laden compressor A1 can also be controlled by the operator through manual mode to start up the operation and stop the interlock.

The degassing valve assembly A4 can independently throttle, decompress and release the inerting medium in the gas source container A3 according to the pressure variation of the inerting medium in the material container U. FIG. In another embodiment, the degassing valve assembly A4 may also be used for opening and closing control by using a combination control mode of one or more of automatic, interlocking and manual modes.

For example, in order to realize the automatic control of the air compressor, the air compressor A1 may be equipped with a first pressure transmitter, which is installed on the gas-side pipe of the air compressor A1, Directly or via the control system communicating with the incoming compressor A1 to detect the pressure variation of the incoming working gas of the incoming compressor A1 and push the automatic control of the incoming compressor A1 to start the operation and shut down The first preset pressure parameter of the lock transmits the signal.

The first pressure transmitter detects in real time the pressure variable used to characterize the inerting medium status in the gas space of the material container. When the pressure variable rises to the first preset pressure threshold, the gas source servo starts the gas receiving procedure: gas The compressor is started to run, and part of the inerting medium in the gas space is transferred, compressed and stored in the gas source container until the pressure variable falls back to a second preset pressure threshold which is not higher than the first preset pressure threshold Machine downtime interlocking, air intake end of the program.

When the pressure variable drops to a third preset pressure threshold that is not higher than the second preset pressure threshold, the gas source servo device starts the gas supply process: the degassing valve control module is turned on, and the inerting medium in the gas source container is warped After the flow and the depressurization are released to the gas space of the material container, the purge valve control assembly is closed until the pressure variable rises to the second preset pressure threshold, and the gas supply process is ended. The third preset pressure threshold is not greater than the second preset pressure threshold. Here to the gas valve control components of the preset pressure threshold of perception and action, either by the common nitrogen valve to achieve, but also by the special pressure transmitter command equipped with electronic control or gas control valve to achieve.

Containers with inert media as the balance of working gas in the system size and breathing in the system without emissions, can effectively eliminate the gas-liquid ratio under the premise of self-sealing gas-liquid exchange loading and unloading operations, and then QHSE integrated storage and transportation System, and be able to generate defensive capabilities to deal with the detonation of the incoming warhead in containers.

In addition to the pressure variable, a preset value of the temperature change signal can also be used to enable interlocking of the start-up compressor with the stop of the compressor to force the circulation of the inerting medium in the material container. In an optional embodiment, the air source servo device further includes a servo thermostat unit for feedback controlling the temperature of the gas space of the material container in an automatic, interlocking and/or manual mode. Specifically, the servo thermostat unit may specifically include a working gas cooling device installed on the exhaust gas side of the intake gas compressor and/or a working gas gas heating device installed on the gas inlet side of the gas removing valve assembly, Gas pipelines and/or gas pipelines, where the temperature transmitters are communicatively connected to the incoming gas compressor either directly or via a control system to detect the temperature variations of the gas phase space of the material container and push the Automatic control to gas compressor start running and shutdown interlocking preset temperature parameter transmission signal.

For some very temperature-sensitive materials (such as benzene, etc.), the need to control the material temperature in the narrower range of values, the servo thermostat temperature control, and the use of gas compressor and degassing valve control components of the material container Within the inert sealing medium forcibly cycle, to achieve precise control of material temperature. In this embodiment, the gas source servo device detects in real time the temperature variables for characterizing the state of the inerting medium in the gas space of the material container and/or the temperature variables for characterizing the external environment of the material container.

Temperature transmitter real-time detection of gas containers used to characterize the gas phase of the gas temperature of the state variables to gas compressor temperature transmitter pushed by the preset temperature threshold signal sent to start or stop the cycle temperature adjustment program, the cycle The temperature program includes: the output of the compressor by the gas, the inerting of the pipeline will be part of the inert material in the container transfer medium, compressed and filled to the gas source container, the accumulation of gas pressure potential energy, and inerting medium thermostat. The cooling process can be realized by cooling the inerting medium through the working gas cooling device, and the heating process can be realized by cooling the inerting medium by the working gas heating device.

At the same time, when the gas valve control component in the gas source servo device senses and/or the detected pressure variable has reached the third preset pressure threshold to start the gas supply program, the gas valve control component is turned on, and the gas source container Of the inert sealing medium temperature, throttling, decompression release to the gas space of the material container until the degassing valve control component senses and/or detects that the pressure variable rises to the second preset pressure threshold, the degassing valve control Components temporarily closed and interlocked, qi program temporarily stopped. Maintain the gas compressor output, the gas pipeline to the part of the material container inerting medium output to the gas valve control components continuously or pulsed open, the gas pipeline after the inerting agent is released into the material container, the gas inerting medium in the material container forms a continuous or pulsed convection temperature control.

In addition to the above-mentioned servo thermostat unit, the outer part of the material container can be further covered with a temperature control structure which is made of airtight metal and/or non-metal hard and/or soft materials, the inner wall of the temperature control structure And the outer surface of the material container to form an atmosphere separated from the interlayer space, the interlayer space can be fully flooded with the inert sealing medium, the inerting tube through the interlayer space and the gas space within the container in communication with the interlayer Space and temperature of the gas space in the material container to control the temperature of the material in the material container to keep the temperature of the material in the material container constant within a preset range.

In an alternative embodiment, the working-substance gas cooling apparatus is also capable of cooling and drying the gas flowing through itself according to properties and components of the condensable gas in the working gas so as to be compatible with the saturated purification component to be more efficient The way to condense, leaching, drawing, removing or diverting back to the material container.

In an optional embodiment, the cycle inert sealing system or the air source servo device further includes an air source purifying unit, which includes a micro-pressure difference purifying component and/or a saturation purifying component, and is configured to operate in a linked, automatic and/or Manual mode controls the condensable or filterable gaseous material in the inerting medium. The micro-pressure difference purification component is arranged in parallel with the gas pipeline, and is connected by a first switch valve group, and the first switch valve group comprises a through-gear and a purge file. The saturated purifying component is arranged in parallel with the pipeline between the gas charging check valve and the gas source container in the gas source servo device, the connection is switched by the second switch valve group, and the second switch valve group comprises the through gear and the purifying gear.

The micro-differential pressure cleaning assembly may specifically include a micro-pressure differential gas-liquid separation device, a purge product diverter valve tube, and a liquid product collection vessel. The bottom of the micro-pressure difference gas-liquid separation device is connected to the liquid product collection container through a unidirectional connection and a liquid-phase valve control through the bottom of the purified product diversion valve pipe for gas phase leaching, liquid phase drawing and drainage, Confluence and recovery of liquid-phase decontamination products and mechanical impurities that flow through their inert media.

The saturant purification assembly may specifically include a pressurized gas-liquid separation device, a first backpressure valve, a purge product diverter valve tube, and a liquid product collection vessel that match the rated discharge pressure of the incoming compressor. The first back pressure valve is arranged on the gas removal side pipe of the pressure type gas-liquid separation device, the bottom of the pressure-type gas-liquid separation device is unidirectionally connected through the purifying product diversion valve pipe and the liquid product collection container and the liquid phase Valve-controlled communication for leaching, draining, diverting, confluence and recovery of liquid-phase purified products flowing through their own inerting medium under pressure.

In addition to the micro-pressure difference and the saturation purification, the gas source purification unit may further include a gas-liquid separation device designed or combined by at least one of filtration, absorption, adsorption, membrane separation, and condensation, To meet the micro-pressure gas-liquid separation device and/or pressure-type gas-liquid separation device to enhance functionality and/or increase efficiency.

In an optional embodiment, the gas source purification unit may further include a third switching valve group, a non-condensable gas removal unit, a third switching valve group Including through-file and purification files. Non-condensable gas removal unit and the gas check valve to the gas source in parallel between the pipeline installed by the third switching valve group connected to switch connection for the linkage, automatic and\or manual removal of inertia mode Medium in the non-condensable or difficult to coagulate impurity gas, impurity gases include at least oxygen.

The non-condensable impurity gas removal unit may specifically include a pressure swing adsorption nitrogen generator, an air compressor, a product removal conduit and a fourth switching valve set. The fourth switching valve set includes a purification gear and a nitrogen gear. The air compressor is arranged in parallel with the air inlet side pipeline of the pressure swing adsorption nitrogen generating unit and is connected and switched by the fourth switching valve group; the removal product produced by the pressure swing adsorption nitrogen generating unit is separated by the removal product Drain the piping to the collection unit or vent it safely.

In each of the embodiments described above, the gas compressor may further be provided with a predetermined gas content sensor which is at least one gas content sensor among oxygen, nitrogen and mass transfer products of the material. The predetermined gas content sensor is communicatively connected to the gas compressor, the first switching valve set, the second switching valve set, the third switching valve set and the fourth switching valve set directly or via the control system for detecting the gas phase of the material container Space, and push for automatic control of the compressor compressor start-up and shutdown interlocks, and the first, second, third and/or fourth switching valve banks are automatically The predetermined parameter of the switched predetermined gas content is transmitted.

When the predetermined gas content sensor detects a high content of some impurity gas (such as condensable, leachable gaseous material or non-condensable gas, etc.), it can be sent to the corresponding gas source purifying unit or the switching valve group in the gas purifying unit A preset parameter transmission signal is sent so that the inert gas containing the inert gas can be removed by the corresponding gas purifying unit or the parallel line of the gas purifying unit.

For example, the predetermined gas is oxygen, the corresponding predetermined gas content sensor is an oxygen content sensor, and the oxygen content sensor is communicatively connected with the gas compressor directly or via a control system for detecting the oxygen ratio of the gas at the gas inlet side So that the compressor and the first switching valve group control the starting operation and the stopping interlock of the compressor and the first switching valve group according to the oxygen proportional variable of the working gas of the intake side.

In another example, the predetermined gas may be methane, and the predetermined gas content sensor is a methane content sensor which is communicatively connected with the source gas compressor and the first switching valve group directly or via a control system for detecting The gas ratio of the gas-side working gas is controlled so that the first input gas switching valve group of the gas compressor controls the start-up operation and the stop of the interlocking device according to the methane ratio of the gas at the intake side. In various embodiments of a gas source servo, one or more of the above-exemplified transmitters or sensors may be employed, as may other transmitters or sensors that are not listed above.

FIG. 2 is a schematic diagram of a second embodiment of a cycle inert sealing system according to the present invention. Compared with the previous embodiment, the gas source servo device in this embodiment may further include a gas source turnover unit in control connection with the servo constant pressure unit for expanding the working gas volume circulated in the gas source servo device, And support the working gas for external output and/or internal input. Specifically, the gas source turnover unit includes a gas storage booster (preferably an electric booster B11), a check valve B2, a surge tank B3 and a make-up valve control Component B4.

The air inlet of the air compressor is connected to the air source container A3 in a one-way manner and is valve-controlled, and can start and stop the interlocking with automatic, interlocking and\or manual mode control to output the air source container A3 Of the working gas, further compressed and filled to the working container B3, and fed back to control the status of the working gas in the gas source container A3 to be kept within the range not greater than the preset pressure parameter.

The filling check valve B2 is matched with the rated exhaust pressure of the accumulator and is arranged on the pipeline between the exhaust side of the accumulator and the intake side of the revolving container B3 for cooperating with the revolving container B3 Store working gas and build pressure potential. The working vessel B3 is matched with the rated exhaust pressure and the preset reserve of the gas storage booster to accumulate the pressure potential energy and store and/or turn the working medium gas. Air control valve assembly B4 to the gas side and gas source container A3 unidirectional connection and valve control connectivity, to self-force, automatic, linkage and\or manual mode control switch to control the working fluid in the working fluid container B3 After the gas is throttled and depressurized, the gas is released to the gas source container A3, and the state of the working gas in the gas source container A3 is feedback-controlled so as to be kept within a range not less than the preset pressure parameter.

In this embodiment, the working gas discharged from the laden compressor A1 may directly enter the air source container A3 through the inflation check valve A2 or be pressed into the revolving container B3 through the air charge booster and the filling check valve B2. The two different airflow paths can be manually or automatically switched by providing an exhaust switching valve control assembly that sets the exhaust switching valve control assembly to the exhaust port of the intake compressor A1 so that the output port passes through the inflation check valve A2 Is connected with the air source container A3, and the other output port is connected with the input port of the air source turnover unit so that the flow of the working medium gas discharged by the air compressor A1 is switched by the valve control unit. Of course, in another embodiment, the pipeline between the compressor A1 and the check valve A2 can also be directly disconnected, so that the compressor A1 can only be charged via the air charger and the charge check The valve B2 and the rotation container B3 are in turn one-way connection and one-way valve control communication.

In this embodiment, the gas source container A3 may serve as a static, limited-capacity container for storing the working gas, and replenishes the material container U as a working gas when the pressure of the material container U is lower than a preset value Seal media. The working fluid container B3 can be used as a kind of dynamic container group with any capacity increase to store the working gas and effectively expand the working gas volume circulating in the gas source servo device and support the working gas output to the external output\Or enter it internally.

In this embodiment, each of the incoming air compressor and the stored air pressure booster has one. In another embodiment, the incoming air compressor and the compressed air compressor may respectively include at least two air-conditioners arranged in parallel, so as to be able to start Operation and shutdown interlock, to adapt to conditions, mutual backup and emergency sharing. Multiple sets of compressor and compressor can be opened or fully opened according to the operating conditions, which can reduce the energy consumption under low demand conditions, so that the system more energy saving.

For the electric supercharger B11, a second pressure transmitter mounted on the intake side of the supercharger B11 and connected directly or via a control system may be provided for detecting the gas The pressure variation of the working gas in the source container A3, the second preset pressure parameter transmission signal to the air charger and the self-starting operation of the electrically-driven supercharger B11 and the stop interlock.

As shown in FIG. 3, which is a schematic diagram of the principle of the third embodiment of the circulating inert seal system of the present invention. Compared with the previous embodiment, this embodiment shows another structure of the gas source turnover unit. The utility model specifically comprises a gas storage booster, a filling check valve B2, a turnover container B3 and a compensating valve assembly B4 which are connected in turn and are in one-way valve control. The gas storage turbocharger is a gas turbocharger B12. The gas turbocharger B12 has a driving gas input interface, a driving gas output interface, a working gas inlet and a working gas outlet. The gas drive turbocharger B12 is also equipped with a relay vessel A31, a drive gas circulation pipe and a circulation gas pressure release valve B5 for driving the working gas discharged from the gas compressor A1 as the driving gas for the gas-boosting compressor B12 Its running.

The air outlet of the air compressor A1 and the driving gas inlet of the air-driven supercharger B12 are unidirectionally connected, and the relay container A31 is connected in series to the pipe between the driving gas outlet and the working medium gas inlet On the road, the driving gas flows through the relay container to the working gas inlet. The working gas outlet is connected to the non-return port of the rotary container B3 through the non-return valve B2. Gas valve assembly B4 to the gas side and the gas source container A1 unidirectional connection and valve control connectivity, to self-force, automatic, linkage and\or manual mode control open and close, to control the working fluid in the working fluid container B3 After throttling and depressurizing, the gas is released to the gas source A3 container, and the gas in the gas source container is fed back to control the state of the working gas, so as to keep the gas at a pressure not less than the preset pressure parameter.

In order to facilitate the connection between the relay container A31 and the air-driven supercharger B12, it is preferable to provide a four-way element in the gas inlet/outlet of the relay container A31. The four-way element has a gas inlet, a gas outlet and a recycle gas outlet And the relay container interface. The relay container interface is connected with the gas inlet/outlet port of the relay container A31, and the gas input interface and the gas output interface are respectively connected with the driving gas outlet of the gas-driven supercharger B12 and the working gas inlet interface.

The drive gas circulation connection is connected to the relay container A31 to the intake side of the compressor A1. The recycle gas pressure release valve B5 is connected in series with the drive gas circulation pipe for limiting the working gas pressure in the relay tank A31 to ensure the drive gas pressure difference between the drive gas input port and the drive gas output port. Compared with the second embodiment, the gas-driven supercharger B12 used in this embodiment not only can realize the transfer, pressurization and storage of the working gas with less power consumption, but also can be applied to occasions with more explosion-proof requirements.

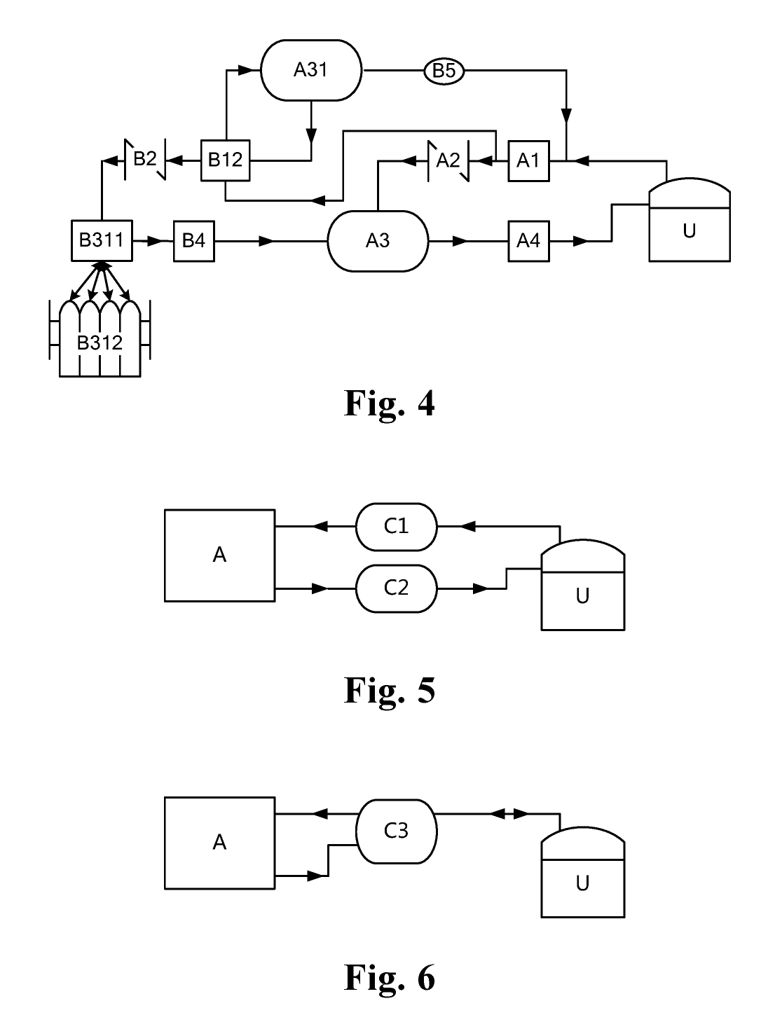

FIG. 4 is a schematic diagram of a fourth embodiment of a cycle inert sealing system according to the present invention. Compared with the previous embodiment of the circulation inerting system including the gas source turnover unit, the rotation container B3 of the gas source servo device in this embodiment is a quick loading cylinder group. Each cylinder B312 in the quick cylinder group is provided with a charging and discharging assembly, and the gas source turnover unit further includes a charging and discharging assembly unit B311 having a gas input interface, a degassing output interface and a cylinder interface, Blowout assembly B311 to the gas input interface connected to the filling check valve B2 gas output side, gas output interface connected to the gas valve control assembly B4 gas input side, the cylinder interface with each cylinder B312 charge and discharge Components connected and two-way valve control connectivity.

Cylinders with quick-loading cylinder group can be replaced, supplemented by the characteristics of the circulating inert sealing system allows the working fluid gas capacity can be adjusted as needed. These inert packing media can be filled into the cylinder when the pressure of the inerting media in the vapor space is too high due to temperature changes in the material tank U or the loading and unloading of the material.

When the cylinder is full, it can be replaced with another empty cylinder. Conversely, if a large amount of inert media is required in the cycle inerting system, the need for a cycle inert seal system can be satisfied by replenishing a cylinder filled with inert media. On the other hand, compared with the fixed tank, the cylinder is inexpensive and easy to popularize.

For the gas source container A3, it can also be in the form of a quick loading cylinder group, that is, each cylinder in the quick loading cylinder group is provided with a charging and discharging assembly, and the servo constant pressure unit further comprises a charging and discharging and collecting assembly, and the charging and discharging and collecting assembly has A gas input interface, a gas output interface and a cylinder interface. The gas input interface of the charging and discharging assembly component is connected to the gas output side of the gas check valve, and the gas output interface is connected to the gas input side of the gas valve control component, Cylinder interface respectively with the charge and discharge components of each cylinder connection and two-way valve control connectivity.

In the above embodiment of the air source servo device, the air source swirling unit may further comprise a gas heating component, the gas heating component is installed outside the high pressure pipeline of the gas compensating valve control component for preventing the pressure pipeline of the gas compensating valve component Vacuum freeze blocking.

In the above embodiments of the circulating inert seal system, in order to perform fire-resistant explosion-proof between the respective material containers and between the material container and the gas source servo device, the buffer container can be connected in series in the inerting pipeline In the buffer container contains fire retardant material. Flameproof flameproof function can also be realized in a material container, that is, a purifying fireproof and explosion-proof component is provided in the material container, the purifying fireproof and explosion-proof component is made of breathable purifying fireproof and explosion-proof material, and the hanging installation Gas inlet and outlet ports in the material container for bidirectional fire-resisting explosion-proof of the inerting medium input to and/or output from the material container.

As shown in FIG. 5, FIG. 5 is a schematic diagram according to a fifth embodiment of the circulating inert seal system of the present invention. In this embodiment, the buffer container includes a gas buffer container C1 connected in series to the gas inlet pipe and having a gas inlet port and a gas outlet port, and a gas buffer tank C1 connected in series to the gas removal pipe, Degassing buffer C2 of the input port and the degassing output port. The exhalation output interface of the material container U is unidirectionally connected to the air supply interface of the air source servo device A through a gas pipe line via a gas buffer container C1 and is in valve-controlled communication. The degassing interface of the air source servo device A is sequentially unidirectionally connected and valve-controlled through the degassing pipeline through the degassing buffer container C2 and the inhalation input interface of the material container U in turn.

For a plurality of material containers, buffer containers may be shared, ie, the material containers U are at least two, the incoming gas inlet ports of the incoming gas buffer container C1 are at least two, the outgoing gas outlet ports of the degassing buffer container C2 are at least two A The exhalation output interfaces of the respective material containers U are respectively connected to the corresponding gas input ports in the gas buffer container C1 through the corresponding gas pipelines. The respective degassing output ports of the de-aeration buffer container C2 are respectively connected with the inhalation input interface of the corresponding material container U through the corresponding degassing lines.

In an optional system embodiment, an expiratory back pressure valve may further be further connected in series to the gas line between the expiration output port of the material container U and the gas buffer container C1. The expiratory back pressure The valve can increase the relief pressure of the inert packing medium in the gas space in the material container U to reduce the starting frequency of the compressor A1. A gas cleaning assembly may be further disposed between the gas supply lines between the material container U and the gas buffer container C1 for purifying the inert packing medium entering the one-way buffer container C1 before buffering.

As mentioned earlier, the material container can be a single container or a container group. In another application scenario, the material container can also be divided into a plurality of containers according to the input and output directions of the material. For a plurality of material containers, which include both a fixed material container and a movable material container (for example, moving a tanker to transport materials between fixed material containers), in order to save labor time, the present invention can be accelerated by adding an acceleration component The flow rate of inert media in the associated idler line and speed up the loading and unloading of liquid materials. That is, the material container may include a fixed material container, a movable material input container, and a movable material output container. A gas acceleration component is also arranged in the gas pipeline, and a degassing acceleration component is also arranged in the degassing pipeline. Both the gas acceleration assembly and the gas removal acceleration assembly include a tube blower to speed up the flow of inert medium in the associated inerting line and speed up the loading and unloading of the liquid phase material.

The fixed material container can be in fluid connection with the movable material input side container and the movable material output side container to convey the material. The gas phase space of the container on the input side of the mobile material is unidirectionally connected and valve-controlled by the gas supply line, the gas buffer and the gas acceleration assembly and the gas supply interface of the gas source servo. The gas phase space of the container on the output side of the mobile material is unidirectionally connected and valve-controlled by the degassing pipeline through the degassing buffer container and the degassing acceleration component to the degassing interface of the gas source servo device. In addition to the line blower, the air acceleration assembly and the gas acceleration assembly may also include assembly components such as a gas phase quick connector and a connecting short tube. Gas phase quick connector and liquid material handling crane tube can be made in combination.

FIG. 6 is a schematic diagram of a sixth embodiment of a cycle inert sealing system according to the present invention. Compared with the fifth embodiment, the present embodiment adopts a bidirectional buffer container C3. In this embodiment, the material container U has a breathing interface, and the idle sealing pipeline includes a gas pipeline, a gas removal pipeline and a breathing pipeline. The buffer container C3 has a gas output port, a gas removal input port, and a breathing gas port. The respiratory interface of the material container U is bidirectionally connected to the respiratory gas port of the buffer container C3 through the breathing tube. The gas output port of the buffer container C3 is unidirectionally connected and valve-controlled with the gas supply port of the gas source servo device A through the gas supply line. The degassing interface of the air source servo device A is unidirectionally connected and valve-controlled through the degassing input port of the degassing pipeline and the buffer container C3.

For a plurality of material containers, the buffer container may be shared, that is, the material container U is at least two, and the buffer container C3 has at least two breathing gas ports. The respiratory interfaces of the respective material containers U are bidirectionally connected to the corresponding respiratory gas ports of the buffer container C3 through respective breathing tubes.

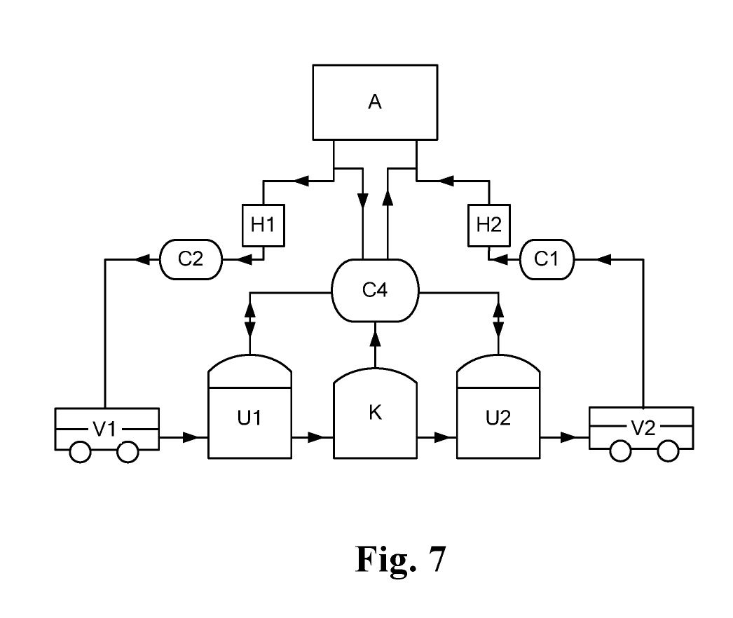

In some specific and complicated material transportation occasions (for example, a plurality of material containers includes both a manufacturing container container and a raw material side container and a product side container), as shown in FIG. 7, Schematic diagram of a seventh embodiment of the system. In this embodiment, the material container may include the manufacturing device container K, the material-side container U1 and the product-side container U2 in addition to the movable-material input-side container V2 and the movable-material output-side container V1. Taking the production of chemical products as an example, the raw material side container U1 is used to supply the chemical raw material to be processed to the production device container K, and the product side container U2 is used for storing chemical products processed by the chemical production device container K. The raw material side container U1, the production device container K and the product side container U2 are sequentially unidirectionally liquid-phase connected and valve-controlled communicated.

Breathing ports of the raw material side container U1 and the product side container U2 are respectively connected with each respiratory gas port of the bridging buffer container C4 in gas phase through the respective breathing tubes for flowing the inerting medium under the action of the liquid level of the material. The movable material output side container V1 and the raw material side container U1 are unidirectionally liquid-phase connected and valve-controlled connected, and the product-side container U2 is connected to the unidirectional liquid phase of the movable material input-side container V2 and communicated in valve control. The gas source servo device A, the degassing acceleration unit H1, the degassing buffer container C2 and the movable material output side container V1 are in unidirectional gas-phase communication with each other, while the movable material input side container V2 and the gas-buffering container C1 accelerate the gas acceleration Component H2 and gas source servo device A unidirectional gas connection.

In the continuous production process, the raw material side container U1 conveys the raw material to the production device container K and the process of conveying the product with the production device container K to the product side container U2 is usually performed at the same time. In this scenario, a bridged buffer container. The buffer container is a bridging buffer container C4, which is used for balancing and flowing without power or low energy consumption of the inert packing medium under the action of the liquid material conveying process.

In the chemical production scenario shown in FIG. 7, the pressure increase caused by the gas-liquid ratio phenomenon is temporarily stored and stored by the air source servo device during the material handling operation, and when the material loading and unloading operation is resumed, The air source servo device then releases part of the inert medium to the raw material side container U1 and the product side container U2.

Taking into account the existing production plant and the container system must be equipped with gas safety relief device, in order to further prevent the safety of the production equipment produced by the safe discharge of gas emissions caused by air pollution and potential safety problems, but also can be used as the gas to be cleaned lazy seal Medium buffer, fire resistance introduced into the cycle of inert sealing system for decompression, cooling, consumer, disposal and utilization. In FIG. 7, the production device container K may also include a safety vent gas line and the bridging buffer container C4 further includes a manufacturing plant safety vent gas input interface. Wherein the safety vent gas line of the production device container K is in one-way connection with the production device safety vent gas input interface of the bridging buffer container C4 to make the safety vent of the production device container K The deflated gas is flame-retarded, flameproofed and buffered by the bridging buffer container C4, and then is dissolved in the raw material container U1 and the product-side container U2 and purified in the air source servo device A, Purification and utilization.

In order to make full use of the original inertia media storage device of the production device container, the air buffer container C1 may further include an external air source input interface, and the de-airing buffer container C2 may further include an internal air source output interface. The inerting medium storage device of the production device container K can be connected and valve-controlled communicated with the circulating inerting system through the external air source input interface of the air-cushioned container C1 and the internal air source output interface of the air-cushioned container C2, respectively Enter the prepared inerting medium into the cycle inert system or the pure inert medium.

The above embodiments of the cycle inert sealing system may also include the above-mentioned saturated purification component, micro-pressure difference purification component, gas cooling component, gas source purification unit or gas source turnover unit. For the specific structure and function, reference may be made to the aforementioned embodiment, Not repeat them here.

In addition, in the embodiments of the cycle inert sealing system, an online monitoring unit for online receiving the technical parameters characterizing the inert sealing medium in the circulating inert sealing system may further be included The on-line warning unit is in communication connection with the online monitoring unit for triggering and remotely pushing the warning signal when the gas state of the inert sealing medium reaches the preset technical parameter value.

Based on the foregoing embodiment of the cycle inerting system, the present invention also provides a QHSE storage and transportation method embodiment. In this embodiment, the incoming gas compressor is provided with a first pressure transmitter mounted on the gas side of the incoming gas compressor, directly or via the control system and the A gas compressor communication connection for detecting a pressure variable of the gas side inerting medium of the gas compressor and pushing a preset pressure parameter for automatically controlling the start of the gas compressor and the shutdown interlock Transmit signal.

The QHSE storage and transportation method includes the following automatic servo respiration steps:

The first pressure transmitter detects in real time a pressure variable for characterizing a state of inerting medium in a gas-phase space of the material container;

When the pressure variable rises to a first preset pressure threshold, the gas source servo device starts a gas-in procedure: the gas-in compressor starts operation, and part of the inerting medium in the gas-phase space is transferred and compressed Storing the gas to the air source container until the pressure variable falls back to a second preset pressure threshold that is not higher than the first preset pressure threshold and the air compressor is stopped and interlocked,

When the pressure variable drops to a third predetermined pressure threshold that is not higher than the second preset pressure threshold, the air source servo device starts the air supply program: the purge valve control module is turned on, and the After the inerting medium in the gas source container is throttled and depressurized, it is released to the gas space of the material container until the pressure variable rises to a second preset pressure threshold, and the degassing valve control assembly is closed Gas program is over.

In another cycle idle system embodiment, the air source servo device may further include a servo temperature control unit, and the servo temperature control unit specifically includes a working gas cooling device installed on the exhaust gas side of the compressor And/or a working gas heating device installed on the gas inlet side of the degassing valve control assembly, and a temperature transmitter mounted on the gas supply line and/or the gas removal line, wherein the temperature change The transmitter communicates with the incoming air compressor directly or via a control system to detect the temperature variation of the gas space of the material container and push the pre-control for controlling the start-up of the incoming air compressor and the shutdown interlock Set the temperature parameter transmission signal.

The QHSE storage and transportation method further comprises a temperature regulating step:

The temperature transmitter detects the temperature variable for characterizing the gas state of the gas phase space of the material container in real time;

When the temperature variable reaches a first preset temperature threshold, the gas source servo device activates the gas-in procedure: the gas-out compressor outputs a part of the inerting medium to be warmed in the material container Transferring and compressing and filling to the gas source container through the inerting pipeline, and accumulating gas pressure potential energy;

When the pressure variable drops to a third predetermined pressure threshold that is not higher than the second preset pressure threshold, the air source servo device starts the air supply program: the purge valve control module is turned on, and the The inerting medium in the gas source container is throttled, decompressed and tempered to be released into the gas space of the material container;

When the temperature variable reaches a preset second temperature threshold corresponding to a desired temperature, the gas compressor stops interlocking and the gas collection process stops; and when the gas removal valve control module senses the second pre-control valve When the pressure threshold is set, the air supply program is stopped, and the automatic temperature control step is ended.

In another embodiment of the inert seal circulation system, an air source purification unit and/or a gas source purification unit may also be included. The air purification unit includes a micro-differential pressure cleaning component and/or a saturation purification component for controlling condensable or filterable gaseous substances in the inert sealing medium in a linked, automatic and/or manual mode. Wherein the micro-pressure differential cleaning assembly is disposed in parallel with the gas pipeline, and the connection is switched by a first switching valve group, and the first switching valve group includes a through-gear and a purifying gear. The saturation purification assembly is disposed in parallel with the pipeline between the gas charging check valve and the gas source container in the gas source servo device and the connection is switched by the second switching valve group, and the second switching The valve block includes through-going and purge files.

The gas purification unit comprises a non-condensable impurity gas removal unit and a third switching valve group, the non-condensable gas removal unit is disposed in parallel with the pipeline between the gas-filled check valve and the gas source container, The third switching valve group is connected with the switching connection for separating and diverting the uncondensed impurity gas flowing through the working gas of the working gas in a linkage, automatic and manual mode, and the non-condensable impurity gas removal unit specifically comprises a Pressure adsorption nitrogen generator, an air compressor and a fourth switching valve group, wherein the air compressor is arranged in parallel with an air inlet side pipeline of the pressure swing adsorption nitrogen generator, the fourth switching valve Group switching connection connectivity.

Inlet compressor is also equipped with a predetermined gas content sensor, the predetermined gas content sensor is at least one gas content sensor among the oxygen, nitrogen and the mass-by-mass products of the material, or a sensor capable of detecting multiple gases; The predetermined gas content sensor is respectively communicated with the gas compressor, the first, the second, the third and the fourth switching valve groups directly or through a control system. Corresponding, QHSE storage and transportation methods also include the following mandatory purification steps:

The predetermined gas content sensor detecting a content variable of a predetermined gas in the gas-phase space in real time;

When the content variable reaches a preset purge start threshold, the air source servo device activates a purge and purge process: the first switch valve group and the second switch valve group are respectively switched to the purge position, and the intake gas compression Machine start-up operation, so that the inerting medium to be purified in the gas-phase space passes through the micro-pressure-difference purification component and/or the saturation purification component to be purified, and then stored in the gas-source container;

When the de-air valve control assembly senses the third preset pressure threshold, purge air supply program is started: the de-air valve control assembly is turned on, and the purified inerting medium in the air source servo device After being throttled and depressurized, released into the gas space of the material container;

When the gas content sensor detects a preset purge shutdown threshold, the gas compressor stops interlocking and the purge valve control assembly senses the second preset pressure threshold and closes, Forced purification step is over.

In the above system embodiment, the QHSE storage and transportation method further includes the following forced purification steps:

When the predetermined gas content sensor detects a preset purifying start value, the gas source servo device activates the gas-in sequence: the third switching valve group switches from the through-gear to the purifying function, and the fourth switching valve Group is switched to the purifying function file, the gas compressor is started to operate so that the inerting medium to be purified in the gas phase space of the material container flows through the gas purifying unit to be purified, and then stored in the gas source container;

When the de-air valve control assembly senses the third preset pressure threshold, the purge gas supply program is started: the de-air valve control assembly is turned on, and the purified inerting medium in the gas source servo device After being throttled and depressurized, released into the gas space of the material container;

When the gas content sensor detects a preset stop threshold value when outputting the inert packing medium to be purified in the gas phase space of the material container and inputting a relatively pure inert sealing medium to form a forced circulation, Shutdown interlock, and when the degassing valve control assembly senses the second preset pressure threshold, the gas supply program is stopped, and the forced purifying step is ended.

According to specific needs, QHSE storage and transportation methods can also include oxygen-evacuation steps:

Switching the third switching valve group to the purifying function; switching the fourth switching valve group to a nitrogen generating function file; starting and running the PSA nitrogen generator and the air compressor, and using the product gas as The inert packing medium is filled into the gas source container;

Shut down the air compressor unit; switch the fourth switch valve group to a purification function;

Start the forced purification step, to the end;

The third switch valve group is switched to the through-gear, and the oxygen-oxygen filling step is completed.

In another embodiment of the inert seal circulation system, the gas source servo device further includes a gas source turnover unit for expanding the working gas volume and capable of outputting the working gas to the outside and/or into the working gas. Reference is made to the foregoing detailed description of the gas source turnover unit, which specifically includes a gas storage booster, a check valve, a surge tank and a refueling valve control assembly connected in sequence and in one-way valve-controlled communication, the revolving container A quick loading cylinder group, each cylinder in the quick loading cylinder group is provided with a charging and discharging assembly, the air source rotation unit further comprises a charging and discharging and collecting assembly, the charging and discharging and collecting assembly has a gas input interface, An output interface and a cylinder interface, a gas input interface of the charging and discharging convergence component is connected to the gas output side of the filling non-return valve, the gas output interface is connected to the gas of the gas compensating valve control component Input side, and the cylinder interfaces are respectively connected with the charging and discharging components of each cylinder and are bidirectionally in valve control communication. Correspondingly, the QHSE storage and transportation method further comprises a gas source external circulation step of replacing the movable cylinder filled with the inert sealing medium with an empty cylinder and/or replacing the unfilled movable cylinder with The removable cylinder filled with the inert packing medium is filled.

The above methods of monitoring and processing the different state parameters of the inert sealing medium are respectively described. In still another system embodiment, the gas source servo device may further include a pressure transmitter, a temperature transmitter, and a predetermined gas content sensor for detecting in real time the pressure of the inert sealing medium in the gas space, the temperature, a predetermined gas Content status. The gas source servo device may further include a monitoring and warning unit for monitoring the internal operation and pushing the warning signal to the outside. Correspondingly, the QHSE storage and transportation method may further include the following steps of: when the pressure transmitter, the temperature transmitter, and/or the predetermined gas content sensor detect the preset warning parameter value, The monitoring and control warning unit remote remote warning signal.

For a system embodiment wherein the material container comprises a fixed material container, a movable material input container and a movable material output container, a gas acceleration component is also connected in series in the gas supply conduit, A series of degassing acceleration components. The QHSE storage and transportation method further comprises the following receiving and accelerating steps and material accelerating steps:

When the movable material output side container is liquid-phase connected with the fixed material container in the circulating inert sealing system to perform the material receiving operation, the gas-phase space of the movable-material output-Loop inerting system connected to the gas pipeline connection;

In the process that the fixed material container receives the material in the movable material output side container, the inerting medium to be purified in the fixed material container flows through the gas inlet pipe, through the gas buffer container and Gas accelerating component to the gas source servo device, and the pure inerting medium in the gas source servo device is sent to the gas-accelerating component through the degassing pipeline, the degas acceleration component and the degassing buffer container, to the gas source servo device, Moving the material output side of the container, until the gas-liquid exchange receiving operation ends, the receiving acceleration step is ended;

When the movable material input side container is connected to the fixed material container in the circulating inert sealing system in a liquid phase to perform the material dispensing operation, the gas phase space of the movable material input side container and the liquid phase space of the Loop inert gas system connected to the gas pipeline connection;

During the process of inputting the fixed material container into the movable material input container, the pure inert medium in the gas source servo device passes through the degassing pipe, the degassed acceleration assembly and the Gas buffer container is conveyed to the fixed material container, the inert material and/or air to be purified in the movable material input container are passed through the gas supply line, and the gas buffer container and the gas supply The accelerator assembly is delivered to the air source servo until the gas-liquid exchange dispensing operation is completed, and the material acceleration step ends.

In the idle sealing cycle system embodiment shown in FIG. 7, the QHSE storage and transportation method may further include the step of dissipating the safety vent gas from the production apparatus: when the safety vent gas generated by the production apparatus container is diverted to the bridging buffer vessel to The raw material-side container and the product-side container, the gas source servo device initiates a forced purification step and/or a forced purification step; and the purified and/or purified production gas in the safety vent gas The inert packing medium is left in the circulating inert sealing system for continued use or removal from circulation, the liquid phase purified product is recovered and the gas phase removal product is collected and utilized.

In addition, QHSE storage and transportation methods can also include the following steps to generate defensive power:

Operating the circulating inert seal system and detecting in real time the gas state variables inside or outside the gas phase space of the material container;

When the charge-breaking wall warhead penetrates the top or wall of the material container and penetrates into the hole with the warhead in the material container, the energy of detonation is released along the gas pipeline for Inhibit the chemical and/or physical explosion of the material;

The detonation energy triggers the air source servo device to start a forced cooling program:

And a part of the inerting medium in the material container is transferred, compressed and filled into the gas source container through the gas pipe line, and the inert medium is cooled down;

The degassing valve control assembly is opened to release the inerting medium in the gas source container to the gas space of the material container through cooling, throttling and decompression;

Under the action of the air source servo device, a continuous or pulsating forced convection circulation for forming an inert sealing medium in the material container for cooling to continuously purify the inert sealing medium to reduce the material vapor concentration;

The air source purifying device continuously produces nitrogen by using air as a raw material, charges the material container through the inert sealing tube, and prevents the air from entering the material container during discharging along the penetration hole.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A gas-supply servo device, comprising: a servo constant pressure unit for supplying, receiving and storing working gas; wherein the servo constant pressure unit comprises: inlet gas compressors which are connected in sequence and communicated and controlled by a one-way valve, a charging check valve, a gas supply container and a degassing valve control unit;
wherein the inlet gas compressors are capable of controlling the start-up and shutdown interlock in automatic, interlocking and\or manual modes, so as to output power to compress and charge the working gas at an inlet side into the gas supply container; so as to feedback control a state of the working gas at the inlet side to be maintained within a range of not greater than a first preset pressure parameter;
the charging check valve, which is matched with a rated exhaust pressure of the inlet gas compressors, is provided on a pipe between an exhaust side of the inlet gas compressors and an inlet side of the gas-supply container, so as to assist the gas-supply container to receive and store the working gas and accumulate pressure potential energy;
the gas-supply container is matched with the rated exhaust pressure and a preset receiving and storing amount of the inlet gas compressor, so as to receive, store and supply the working gas; and
the degassing valve control unit is capable of controlling opening and closing in an independent, automatic, interlocking and/or manual mode to control the working gas in the gas supply container to be throttled and decompressed to be released to a degassing side of the degassing valve control unit, and to feedback control a state of the working gas at the degassing side of the degassing valve control unit to be maintained within a range of not less than a second preset pressure parameter.

2. The gas-supply servo device, as recited in claim 1, wherein the inlet gas compressor is equipped with a first pressure transmitter, wherein the first pressure transmitter is provided on a pipe on an inlet side of the inlet gas compressor, so as to directly communicated and connected with the inlet compressor or via a control system to detect pressure variable of working gas at the inlet side of the inlet compressor and push a first preset pressure parameter transmission signal for automatically controlling the start-up and shutdown interlock of the inlet compressor.

3. The gas-supply servo device, as recited in claim 1, further comprises a gas source turnover unit for expanding a volume of the working gas and being capable of outputting the working gas to an external and/or an internal; the gas source turnover unit comprises: a gas storage booster, a charging and filling check valve, a turnover container and a compensation valve control unit which are sequentially connected and communicated by a one-way valve;
wherein an inlet side of the gas storage booster is in one-way connection with the gas supply container and communicated by valve control; the gas storage booster is capable of controlling start-up and stop interlock in an automatic, interlocking and\or manual mode, so as to output power to transfer the working gas in the gas-supply container to further compress and discharge and fill the working gas to the turnover container, and feedback control the working gas in the gas-supply container to be maintained in a range of not exceeding the preset pressure parameter;
the charging and filling check valve which is matched with a rated exhaust pressure of the gas storage booster, is provided on a pipe between an side of the gas storage booster and an inlet side of the turnover container, so as to assist the turnover container to receive and store the working gas and accumulate pressure potential energy;
the turnover container is matched with a rated discharge pressure and a preset receiving and storing amount of the gas storage booster for accumulating pressure potential energy to store and circulate the working gas;
the compensation valve control unit is capable of controlling opening and closing in an independent, automatic, interlocking and/or manual mode to control the working gas in the turnover container to be throttled and decompressed to be released to the gas supply container, and to feedback control a state of the working gas in the gas-supply container to be maintained within a range of not less than a preset pressure parameter.

4. The gas-supply servo device, as recited in claim 3, wherein the gas storage booster is an electric drive booster, a second pressure transmitter is provided on an inlet side of the electric drive booster, so as to directly communicated and connected with the electric drive booster or via a control system to detect pressure variable of the working gas in the gas-supply container and push a second preset pressure parameter transmission signal for automatically controlling the start-up and shutdown interlock of the gas storage booster.

5. The gas-supply servo device, as recited in claim 1, further comprising a gas-supply turnover unit for expanding a volume of the working gas and being capable of outputting the working gas to an external and/or inputting the working gas to an internal;
wherein the gas-supply turnover unit comprises: a gas storage booster, a charging and filling check valve, a turnover container and a compensation valve control unit which are sequentially s and communicated by a one-way valve; wherein the gas storage booster is a gas drive booster, the gas drive booster has a drive gas input interface, a drive gas output interface, a working gas inlet and a working gas outlet; the gas drive booster is also equipped with a relay container for driving a gas recycle pipe, a driving gas recycle pipe and a recycle gas pressure relief valve for driving the gas drive booster to operate via a driving gas of the working gas discharged by the inlet gas compressor;
an air outlet of the inlet compressor is in a one-way connection and communication with a driving gas input port of the gas drive booster; the relay container is connected in series to a pipe between the driving gas outlet and a working gas inlet, the driving gas passes through the relay container to the working gas inlet; the working gas outlet is connected and communicated with the inlet of the turnover container by the charging and filling check valve in a non-return way;
an outlet side of the compensation valve control unit is connected and communicated with the gas-supply container in one way; the compensation valve control unit is capable of controlling opening and closing in an independent, automatic, interlocking and/or manual mode to control the working gas in the turnover container to be throttled and decompressed to be released to the gas supply container, and to feedback control a state of the working gas in the gas-supply container to be maintained within a range of not less than a preset pressure parameter;
the driving gas recycle pipe is connected on an inlet side of the relay container and the inlet compressor; the circulating gas pressure relief valve is connected in series with the driving gas recycle pipe to limit pressure of the working gas in the relay container, so as to ensure a driving gas pressure difference between the driving gas inlet and the driving gas outlet.

6. The gas-supply servo device, as recited in claim 3, wherein the turnover container is a ready packaged steel cylinder unit; each steel cylinder of the ready packaged steel cylinder unit comprises a charging and discharging assembly; the gas supply turnover unit further comprises a charging and discharging converge unit; wherein the charging and discharging converge unit comprises: a gas input interface, a gas output interface and a steel cylinder interface; the gas input interface of the charging and discharging converge unit is connected on a gas output side of the charging and filling check valve, the gas output interface is connected on a gas input side of the compensation valve control unit; the steel cylinder interface is respectively connected and communicated with the charging and discharging assembly of each of the steel cylinder by a two-way valve.

7. The gas-supply servo device, as recited in claim 1, wherein the turnover container is a ready packaged steel cylinder unit; each steel cylinder of the ready packaged steel cylinder unit comprises a charging and discharging assembly; the servo constant pressure unit further comprises a charging and discharging converge unit; wherein the charging and discharging converge unit comprises: a gas input interface, a gas output interface and a steel cylinder interface; the gas input interface of the charging and discharging converge unit is connected on a gas output side of the charging and filling check valve, the gas output interface is connected on a gas input side of the compensation valve control unit; the steel cylinder interface is respectively connected and communicated with the charging and discharging assembly of each of the steel cylinder by a two-way valve.

8. The gas-supply servo device, as recited in claim 3, wherein a gas heating device is provided on the compensation valve control unit, so as to prevent decompression freezing blockage of the compensation valve control unit.

9. The gas-supply servo device, as recited in claim 3, wherein an amount of the inlet gas compressors is at least two, an amount of the gas storage boosters is at least two; wherein the inlet gas compressors and the gas storage boosters respectively connected in parallel and are capable of being started one after another and respectively shutdown for interlock, so as to adapt to operating conditions for serving as mutual backup and emergency sharing.

10. A circulating insert-gas seal system based on the gas-supply servo device as recited in claim 1, comprising: the gas-supply servo device, an insert-gas seal pipe and a material container; wherein the working gas is an inert sealing medium which is a gas-type fire-fighting medium applied by a suffocation fire-fighting method; wherein the gas-supply servo device has an inlet interface and an outlet interface; the inlet interface is the inlet port of the inlet gas compressors, the outlet interface is the outlet port of the gas outlet valve control unit; the insert-gas seal pipe comprises an inlet pipe and an outlet pipe; an expiration output interface and an inspiration input interface; wherein the expiration output interface of the material container is connected in sequence with the inlet port of the gas-supply servo device via the inlet pipe and communicated and controlled by a first one-way valve; the inspiration input interface of the material container is connected in sequence with the outlet port of the gas-supply servo device via the outlet pipe and communicated and controlled by a second one-way valve, so as to feedback control gas conditions of the insert sealing medium in a gas phase space of the material container.

11. The circulating insert-gas seal system, as recited in claim 10, wherein the gas-supply servo device further comprises a servo temperature regulating unit for feedback controlling a temperature of the gas phase space of the material container in an automatic, interlocking and/or manual mode.

12. The circulating insert-gas seal system, as recited in claim 11, wherein the servo temperature regulating unit comprises: a working gas cooling device provided on an exhaust side of the inlet gas compressor and/or a working gas heating device provided on a degassing side of the degassing valve control unit, and a temperature transmitter provided on the inlet pipe or the outlet pipe; wherein the temperature transmitter is connected and communicated with the inlet gas compressors directly or via a control system, so as to detect a temperature variable of the gas phase space of the material container and push a preset temperature parameter transmission signal for automatically controlling a start-up operation and shutdown interlock of the inlet gas compressors.

13. The circulating insert-gas seal system, as recited in claim 11, wherein a temperature regulating structure is cover on an external of the material container; the temperature regulating structure is made of airtight metal and/or non-metal, hard and\or soft material, an interlayer space separated from the atmosphere is formed between an internal wall of the temperature regulating structure and an external surface of the material container; the insert seal pipe is communicated with the gas-phase space of the material container via the interlayer space, so as to control temperature of materials in the material container by regulating temperatures of the gas-phase space in the material container and the interlayer space.

14. The circulating insert-gas seal system, as recited in claim 10, further comprising a gas source purifying unit, wherein the gas source purifying unit comprises a micro-pressure difference purifying unit and/or a saturation purifying unit, the gas source purifying unit is configured to control condensable or filterable gaseous substances in the insert sealing medium in a linked, automatic and/or manual mode; wherein the micro-pressure difference purifying unit is connected in parallel with the inlet pipe, wherein connection and communication is switched by a first switching valve group which comprises a first through gear and a first purifying gear; the saturation purifying unit is provided in parallel with the pipe between the charging check valve and the gas-supply container in the gas-supply servo device and is connected and communicated by a second switching valve group; wherein the second through gear and a second purifying gear.

15. The circulating insert-gas seal system, as recited in claim 14, wherein the micro pressure difference purifying component specifically comprises a micro-pressure difference gas-liquid separation device, a purge product diverter valve tube and a liquid product collection container, wherein a bottom of the micro-pressure difference gas-liquid separation device is in one-way connection with the liquid product collection container through the purifying product diversion valve tube, the liquid phase valve is controlled in communication with the liquid phase to drain the liquid phase in the micro-pressure difference condition, and the liquid Phase absorbing, purging, converging, and recovering liquid-phase purified products and mechanical impurities flowing through its own inerting medium; and the saturated purification component specifically includes a pressure-type gas matching the rated discharge pressure of the incoming compressor Liquid separation device, a first back pressure valve, a purge product diversion valve pipe and a liquid product product collection container, wherein the first back pressure valve is disposed on the degassing side pipe of the pressure-type gas-liquid separation device, and the The bottom of the pressure-type gas-liquid separation device is unidirectionally connected to the liquid product collection container via the purifying product diversion valve tube and is in liquid-phase valve control for leaching, drawing and grooming under a pressure condition, confluence and recycling flow through their own lazy seal Interstitial liquid in the purified product.

16. The circulating insert-gas seal system, as recited in claim 15, wherein the air source purifying unit further comprises a gas-liquid separation device produced by a method selected from a group consisting of a filter method, an absorption method, an adsorption method, a membrane separation method and a condensation method, so as to cooperate with the micro-pressure differential gas-liquid separation device and/or the pressure-type gas-liquid separation device to enhance function and/or improve efficiency.

17. The circulating insert-gas seal system, as recited in claim 14, further comprising a gas source purifying unit, wherein the gas source purifying unit comprises a third switch valve group and a non-condensable impurity gas removal unit; the third switch valve group comprises a through-going gear and a purifying gear, the non-condensable gas removal unit and the pipeline between the gas-filled check valve and the gas source container are arranged in parallel, and the third switchover valve; a valve bank switching connection is provided for removing the non-condensable or difficult-to-coagulant-type impurity gas in the inert packing medium in an interlocked, automatic and/or manual mode; the impurity gas comprises at least oxygen.

18. The circulating inert-gas seal system, as recited in claim 17, wherein the non-condensable impurity gas removal unit specifically comprises a pressure swing adsorption nitrogen generator, an air compressor, a product removal pipe and a fourth switch valve group, wherein the fourth switch valve group comprises a purification file and a nitrogen gear, wherein the air compressor is provided in parallel with an air inlet side pipeline of the pressure swing adsorption nitrogen generating unit, and is connected and communicated by the fourth switch valve group; the removal products generated by the PSA nitrogen generator are diverted to the collection device or safely vented through the removal product drain conduit.

19. The circulating inert-gas seal system, as recited in claim 18, wherein a predetermined gas content sensor is provided on the inlet gas compressor, which is an interconversion product of oxygen, nitrogen and materials at least one of the gas content sensor, the predetermined gas content sensor directly connected and communicated with, or via a control system and the intake compressor, the first switching valve group, the second switching valve group, the third switching valve group and or a fourth switching valve set for detecting a predetermined gas content of the gas phase space of the material container and for pushing an automatic control of the starting gas compressor start and stop interlocks and the first switching valve set, the second switching valve set, the third switching valve set and the fourth switching valve set automatically switches the predetermined gas content of the predetermined parameter transmission signal.

20. The circulating inert-gas seal system, as recited in claim 10, wherein a buffer container is connected in series in the inert sealing pipe, and the interior of the buffer container is provided with a fire-proof and explosion-proof material for discharging the oxygen between the material containers, and between the material container and the gas source servo device.

21. The circulating inert-gas seal system, as recited in claim 20, wherein the buffer container comprises a gas buffer container connected in series with the gas inlet and the gas outlet in the gas line, and a degassing buffer container connected to the degassing line in series and having a degassing input port and a degassing output port, wherein the breath output interface of the material container is connected to the degassing gas passage via the gas conduit, the air supply buffer and the air supply interface of the air source servo device are connected and valve-controlled in sequence; the air removal interface of the air source servo device is connected to the air supply port of the air source servo device via the air removal buffer via the air removal buffer container, The suction inlet of the material container is in turn connected and valve-controlled in one-way.

22. The circulating inert-gas seal system, as recited in claim 21, wherein at least two of the material containers are used, at least two gas inlet ports of the gas buffer container are provided, wherein the exhalation output interfaces of the respective material containers are connected to the corresponding gas inlet ports in the gas buffer container via the corresponding gas pipelines respectively; and the degassing buffer container of the respective gas output port is respectively connected and communicated with the corresponding degassing line and the corresponding material container suction inlet.

23. The circulating inert-gas seal system, as recited in claim 21, wherein the material container comprises a fixed material container, a movable material input container and a movable material output container; a gas acceleration component is also connected in series with the inlet gas pipe, and a degassing acceleration component is also connected in series in the degassing pipeline, both the gas acceleration component and the degassing acceleration component comprise a pipeline fan to speed up the inerting medium at And the speed of loading and unloading of the liquid phase material is accelerated; the fixed material container can be in liquid phase connection with the movable material input container and/or the movable material output container , And the material in the input side of the movable material is unidirectionally connected to the air inlet of the air source servo device via the gas supply line via the gas buffer container and the gas acceleration assembly, the gas phase space of the container on the output side of the moving material passes through the degassing pipe, the degassing buffer container, the degassing accelerating assembly, the degassing of the gas source servo device valve opening are connected and communicated by one-way valve.

24. The circulating inert-gas seal system, as recited in claim 20, wherein the material container has a breathing interface, the inert seal pipe comprises a gas inlet pipe, a gas removal tube and a breathing tube, the buffer container has a breath outlet port, a degassing input port, and a breath port, wherein the breath port of the material container is bidirectionally connected to the breath port of the buffer container through the breath tube; the gas supply to the buffer container; the output port is unidirectionally connected to the air supply interface of the air source servo device through the air supply pipeline and is in valve-controlled communication; the degassing interface of the air source servo device is connected to the buffer container through the degassing pipeline one-way inlet connection and valve control connectivity.

25. The circulating inert-gas seal system, as recited in claim 24, wherein at least two of the material containers are used, and at least two respiratory gas ports of the buffer container are used, wherein breathing ports of the respective material containers respectively pass through the respective breathing tubes are bidirectionally connected to the corresponding breathing gas ports on the buffer container.

26. The circulating inert-gas seal system, as recited in claim 25, wherein the buffer container is a bridging buffer container, and the material container further comprises a manufacturing device container, and a raw material container and a product-side container, wherein the raw material side container, the production device container and the product-side container are sequentially and unidirectionally connected and communicated with the liquid-phase connected and in valve-controlled communication, wherein the breathing ports of the material-side container and the product-side container respectively communicate with each other through respective breathing circuits and each breathing gas port of the bridging buffer container is in gas-phase connection and is used for flowing the inert seal medium under the action of the liquid level of the material.

27. The circulating inert-gas seal system, as recited in claim 26, wherein the production device container further comprises a safety vent gas pipe, and the bridging buffer container further comprises a production device safety vent gas input interface, the safety vent gas line of the production device container communicates with the non-return one-way connection of the production device safety vent gas input interface of the bridging buffer container to make the safety vent gas of the production device container pass through the bridging buffer container is fire-resistant, explosion-proof and cushioned, is disposed of in the raw material container and the product-side container, and is purified, purified and utilized in the air source servo device.

28. The circulating inert-gas seal system, as recited in claim 24, wherein the gas buffer container further comprises an external gas source input interface, and the gas degassing buffer container further comprises an internal gas source output interface.

29. The circulating inert-gas seal system, as recited in claim 10, wherein a flameproof and explosion-proof component is provided on the inlet and the outlet of the material container to perform two-way pipe flame retardant explosion suppression between the material container and the inert seal pipe.

30. The circulating inert-gas seal system, as recited in claim 10, further comprising an online monitoring unit and an online warning unit for on-line monitoring characteristics of the circulating inert seal system that characterize the inert seal And the on-line warning unit is connected and communicated with the online monitoring unit for triggering and remotely pushing the warning signal when the gas state of the inert sealing medium reaches the preset technical parameter value.

31. The gas-supply servo device, as recited in claim 10, wherein the inlet gas compressor is equipped with a first pressure transmitter, wherein the first pressure transmitter is provided on a pipe on an inlet side of the inlet gas compressor, so as to directly communicated and connected with the inlet compressor or via a control system to detect pressure variable of working gas at the inlet side of the inlet compressor and push a first preset pressure parameter transmission signal for automatically controlling the start-up and shutdown interlock of the inlet compressor.

32. The gas-supply servo device, as recited in claim 10, further comprises a gas source turnover unit for expanding a volume of the working gas and being capable of outputting the working gas to an external and/or an internal; the gas source turnover unit comprises: a gas storage booster, a charging and filling check valve, a turnover container and a compensation valve control unit which are sequentially connected and communicated by a one-way valve;
wherein an inlet side of the gas storage booster is in one-way connection with the gas supply container and communicated by valve control; the gas storage booster is capable of controlling start-up and stop interlock in an automatic, interlocking and\or manual mode, so as to output power to transfer the working gas in the gas-supply container to further compress and discharge and fill the working gas to the turnover container, and feedback control the working gas in the gas-supply container to be maintained in a range of not exceeding the preset pressure parameter;
the charging and filling check valve which is matched with a rated exhaust pressure of the gas storage booster, is provided on a pipe between an side of the gas storage booster and an inlet side of the turnover container, so as to assist the turnover container to receive and store the working gas and accumulate pressure potential energy;
the turnover container is matched with a rated discharge pressure and a preset receiving and storing amount of the gas storage booster for accumulating pressure potential energy to store and circulate the working gas;
the compensation valve control unit is capable of controlling opening and closing in an independent, automatic, interlocking and/or manual mode to control the working gas in the turnover container to be throttled and decompressed to be released to the gas supply container, and to feedback control a state of the working gas in the gas-supply container to be maintained within a range of not less than a preset pressure parameter.

33. The gas-supply servo device, as recited in claim 32, wherein the gas storage booster is an electric drive booster, a second pressure transmitter is provided on an inlet side of the electric drive booster, so as to directly communicated and connected with the electric drive booster or via a control system to detect pressure variable of the working gas in the gas-supply container and push a second preset pressure parameter transmission signal for automatically controlling the start-up and shutdown interlock of the gas storage booster.

34. The gas-supply servo device, as recited in claim 10, further comprising a gas-supply turnover unit for expanding a volume of the working gas and being capable of outputting the working gas to an external and/or inputting the working gas to an internal; wherein the gas-supply turnover unit comprises: a gas storage booster, a charging and filling check valve, a turnover container and a compensation valve control unit which are sequentially s and communicated by a one-way valve; wherein the gas storage booster is a gas drive booster, the gas drive booster has a drive gas input interface, a drive gas output interface, a working gas inlet and a working gas outlet; the gas drive booster is also equipped with a relay container for driving a gas recycle pipe, a driving gas recycle pipe and a recycle gas pressure relief valve for driving the gas drive booster to operate via a driving gas of the working gas discharged by the inlet gas compressor;
an air outlet of the inlet compressor is in a one-way connection and communication with a driving gas input port of the gas drive booster; the relay container is connected in series to a pipe between the driving gas outlet and a working gas inlet, the driving gas passes through the relay container to the working gas inlet; the working gas outlet is connected and communicated with the inlet of the turnover container by the charging and filling check valve in a non-return way;
an outlet side of the compensation valve control unit is connected and communicated with the gas-supply container in one way; the compensation valve control unit is capable of controlling opening and closing in an independent, automatic, interlocking and/or manual mode to control the working gas in the turnover container to be throttled and decompressed to be released to the gas supply container, and to feedback control a state of the working gas in the gas-supply container to be maintained within a range of not less than a preset pressure parameter;
the driving gas recycle pipe is connected on an inlet side of the relay container and the inlet compressor; the circulating gas pressure relief valve is connected in series with the driving gas recycle pipe to limit pressure of the working gas in the relay container, so as to ensure a driving gas pressure difference between the driving gas inlet and the driving gas outlet.

35. The gas-supply servo device, as recited in claim 32, wherein the turnover container is a ready packaged steel cylinder unit; each steel cylinder of the ready packaged steel cylinder unit comprises a charging and discharging assembly; the gas supply turnover unit further comprises a charging and discharging converge unit; wherein the charging and discharging converge unit comprises: a gas input interface, a gas output interface and a steel cylinder interface; the gas input interface of the charging and discharging converge unit is connected on a gas output side of the charging and filling check valve, the gas output interface is connected on a gas input side of the compensation valve control unit; the steel cylinder interface is respectively connected and communicated with the charging and discharging assembly of each of the steel cylinder by a two-way valve.

36. The gas-supply servo device, as recited in claim 10, wherein the turnover container is a ready packaged steel cylinder unit; each steel cylinder of the ready packaged steel cylinder unit comprises a charging and discharging assembly; the servo constant pressure unit further comprises a charging and discharging converge unit; wherein the charging and discharging converge unit comprises: a gas input interface, a gas output interface and a steel cylinder interface; the gas input interface of the charging and discharging converge unit is connected on a gas output side of the charging and filling check valve, the gas output interface is connected on a gas input side of the compensation valve control unit; the steel cylinder interface is respectively connected and communicated with the charging and discharging assembly of each of the steel cylinder by a two-way valve.

37. The gas-supply servo device, as recited in claim 32, wherein a gas heating device is provided on the compensation valve control unit, so as to prevent decompression freezing blockage of the compensation valve control unit.

38. The gas-supply servo device, as recited in claim 32, wherein an amount of the inlet gas compressors is at least two, an amount of the gas storage boosters is at least two; wherein the inlet gas compressors and the gas storage boosters respectively connected in parallel and are capable of being started one after another and respectively shutdown for interlock, so as to adapt to operating conditions for serving as mutual backup and emergency sharing.

39. A QHSE (quality, health, safety and environmental) storage and transportation method based on the circulating insert-gas seal system, as recited in claim 10, wherein the air inlet compressor is provided with a first pressure transmitter, and the first pressure transmitter is installed on the pipeline on the gas side of the incoming gas compressor and is connected and communicated with the incoming gas compressor directly or via a control system to detect whether the incoming gas compressor pressure variable and pushing a preset pressure parameter transmission signal for automatically controlling the start-up of the incoming compressor and the shutdown interlock;
the QHSE storage and transportation method comprises following automatic servo respiration steps of:
the first pressure transmitter detects in real time a pressure variable for characterizing a state of inerting medium in a gas-phase space of the material container;
when the pressure variable rises to a first preset pressure threshold, the gas source servo device starts a gas-in procedure: the gas-in compressor starts operation, and part of the inerting medium in the gas-phase space is transferred and compressed Storing the gas to the air source container until the pressure variable falls back to a second preset pressure threshold that is not higher than the first preset pressure threshold and the air compressor is stopped and interlocked,
when the pressure variable drops to a third predetermined pressure threshold that is not higher than the second preset pressure threshold, the air source servo device starts the air supply program: the purge valve control module is turned on, and the After the inerting medium in the gas source container is throttled and depressurized, it is released to the gas space of the material container until the pressure variable rises to a second preset pressure threshold, and the degassing valve control assembly is closed Gas program is over.

40. The QHSE based storage and transportation method based on wherein the air source servo device further comprises a servo temperature control unit, and the servo temperature control unit specifically comprises a servo control unit mounted on the air compressor row A gas-side refrigerant gas cooling device and/or a refrigerant gas heating device installed on the gas-inlet side of the degassing valve control module and a temperature transmitter installed on the gas-supply line and/or the degassing line Wherein the temperature transmitter is in communication with the incoming air compressor directly or via a control system to detect a temperature variable of the gas space of the material container and push a temperature sensor for controlling the incoming air compressor Start running and stop interlocking preset temperature parameter transmission signal;
the QHSE based storage and transportation method further comprises a temperature regulating step:
the temperature transmitter detects the temperature variable for characterizing the gas state of the gas phase space of the material container in real time;
when the temperature variable reaches a first preset temperature threshold, the gas source servo device activates the gas-in procedure: the gas-out compressor outputs a part of the inerting medium to be warmed in the material container Transferring and compressing and filling to the gas source container through the inerting pipe, and accumulating gas pressure potential energy;
when the pressure variable drops to a third predetermined pressure threshold that is not higher than the second preset pressure threshold, the air source servo device starts the air supply program: the purge valve control module is turned on, and the inerting medium in the gas source container is throttled, decompressed and tempered to be released into the gas space of the material container;
when the temperature variable reaches a preset second temperature threshold corresponding to a desired temperature, the gas compressor stops interlocking and the gas collection process stops; and when the gas removal valve control module senses the second pre-control valve When the pressure threshold is set, the air supply program is stopped, and the automatic temperature control step is ended.

41. The QHSE storage and transportation method according to claim 39, wherein the material container comprises a fixed material container, a movable material input container and a movable material output container, wherein the gas supply conduit is further connected in series, a gas acceleration component is provided, and the gas removal acceleration component is also connected in series in the gas removal pipeline; the QHSE storage and transportation method further comprises the following material collection acceleration steps and material acceleration steps:
when the movable material output side container is liquid-phase connected with the fixed material container in the circulating inert sealing system to perform the material receiving operation, the gas-phase space of the movable-material output-loop inerting system connected to the gas pipeline connection;
in the process that the fixed material container receives the material in the movable material output side container, the inerting medium to be purified in the fixed material container flows through the gas inlet pipe, through the gas buffer container and Gas accelerating component to the gas source servo device, and the pure inerting medium in the gas source servo device is sent to the gas-accelerating component through the degassing pipeline, the degas acceleration component and the degassing buffer container, to the gas source servo device, Moving the material output side of the container, until the gas-liquid exchange receiving operation ends, the receiving acceleration step is ended;
when the movable material input side container is connected to the fixed material container in the circulating inert sealing system in a liquid phase to perform the material dispensing operation, the gas phase space of the movable material input side container and the liquid phase space of the Loop inert gas system connected to the gas pipeline connection;
during the process of inputting the fixed material container into the movable material input container, the pure inert medium in the gas source servo device passes through the degassing pipe, the degassed acceleration assembly and the Gas buffer container is conveyed to the fixed material container, the inert material and/or air to be purified in the movable material input container are passed through the gas supply line, and the gas buffer container and the gas supply The accelerator assembly is delivered to the air source servo until the gas-liquid exchange dispensing operation is completed, and the material acceleration step ends.

42. The QHSE storage and transportation method according to claim 39, further comprising the following steps of coercively sampling the atmosphere:
the material container is placed in a pit garage and the circulating inert seal system is operated to disable the atmospheric compulsory sampling reconnaissance capability.

43. The QHSE storage and transportation method according to claim 39, wherein the QHSE storage and transportation method further comprises the following steps of generating defensive battle force:
operating the circulating inert seal system and detecting in real time the gas state variables inside or outside the gas phase space of the material container;
when the charge-breaking wall warhead penetrates the top or wall of the material container and penetrates into the hole with the warhead in the material container, the energy of detonation is released along the gas pipeline for Inhibit the chemical and/or physical explosion of the material;
the detonation energy triggers the air source servo device to start a forced cooling program: the air compressor is used to output a forced cooling force, and a part of inert medium in the material container is transferred, compressed and filled up to The gas source container, and cooling the inert sealing medium;
the degassing valve control assembly is opened to release the inerting medium in the gas source container to the gas space of the material container through cooling, throttling and decompression;
under the action of the air source servo device, a continuous or pulsating forced convection cycle of inerting medium is formed in the material container to cool down continuously to continuously reduce the concentration of material vapor, Torr hole to prevent air from entering the material container during discharge.
